(19) United States
(12) Patent Application Publication
(10) Pub. No.: US 2004/0138335 A1
(43) Pub. Date: Jul. 15, 2004

(54) Ink composition and ink-jet recording method

(76) Inventors: Kenji Ikeda, Shizuoka-ken (JP); Takahiro Ishizuka, Kanagawa (JP)

Correspondence Address: Sheldon J. Moss, c/o Yumi Yerks, Appartment #412-North, 2111 Jefferson Davis Highway, Arlington, VA, 22202, US

(21) Appl. No.: 10/622,746

(22) Filed: Jul. 21, 2003

(30) Foreign Application Priority Data
Jul. 23, 2002 (JP) 2002-214237

(51) Int. Cl. C09D 11/00; C09D 11/02; B41J 2/01; C03C 17/00; C09D 5/00

(52) U.S. Cl. 523/160; 106/31.27; 106/31.44; 106/31.43; 106/31.51; 106/31.52; 106/31.49; 106/31.58; 106/31.57; 347/100; 523/161

(57) ABSTRACT

The present invention provides an aqueous ink composition including a hydrophilic organic solvent, a surfactant, and a colored fine particle dispersion which contains an oil-soluble dye, and exhibiting a dynamic surface tension of 25 to 35 mN/m, as well as an ink-jet recording method including a step of carrying out recording using the aqueous ink composition.

### CROSS-REFERENCE TO RELATED APPLICATION

This application claims priority under 35 USC 119 from Japanese Patent Application No. 2002-214237, the disclosure of which is incorporated by reference herein.

### BACKGROUND OF THE INVENTION

1. Field of the Invention

The present invention relates to an aqueous ink composition comprising a colored fine particle dispersion as well as to an ink-jet recording method using the ink composition. More specifically, the invention relates to an ink composition having good ejectibility as well as to an ink-jet recording method using the ink composition.

2. Description of the Related Art

With a rising spread of computers in recent years, ink-jet printers are widely used for printing on paper, film and cloth not only in offices but also in homes. As inks used for ink-jet recording, oil-based inks, aqueous inks and solid inks are known, among which aqueous inks are particularly advantageous in view of ease of production, handling, odor and safety, and hence are mainly used.

Most of the aqueous inks contain water-soluble dyes which are soluble in a molecular state to thereby provide advantages of high transparency and high color density. However, because of water-solubility of the dyes, the aqueous inks have disadvantages of poor water resistance, generation of bleeding upon printing on a plain paper so as to seriously reduce print quality, poor light resistance, and severely impaired image storability due to the effect of oxidizing gases (SOₓ, NOₓ, ozone, etc.) on a recording paper having on a surface thereof an ink-receiving layer that contains porous inorganic fine particles (hereinafter sometimes referred to as a photographic quality paper).

In order to solve the aforementioned problems, aqueous inks prepared using pigments or disperse dyes have been proposed, for example, in Japanese Patent Application Laid-Open (JP-A) Nos. 56-157468, 4-18468, 10-110126 and 10-195355.

These proposed aqueous inks provide improvement in water resistance to some degree, althogh far below a satisfactory level, but pose problems of poor storability of a dispersion of the pigments or disperse dyes and a tendency for clogging at an ink ejecting port. Further, the inks containing the pigments or the dyes have problems of poor penetration into a photographic paper and a tendency for peeling of the pigment or the dye when rubbed with a hand.

On the other hand, there is proposed in JP-A Nos. 58-45272, 6-340835, 7-268254, 7-268257 and 7-268260 a method of incorporating a dye into dispersed particles made of urethane or polyester. However, such an ink-jet ink obtained through this method has poor color tone, low color reproducibility and insufficient fading resistance. Further, when used for printing on a photographic quality paper, the ink is low in abrasion resistance when rubbed with an eraser.

Thus, the current situation is that there has not yet been provided an ink composition containing a colored fine particle dispersion, which is excellent in handling, odor and safety, has dispersed particles having a small diameter, is good in dispersibility and storability of the dispersion, and is sufficient to meet the requirements of ink, when the composition is applied thereto, such as ejecting stability without clogging at a nozzle tip, good color development and color tone (hue) irrespective of a type of paper used, excellent ink permeability even on the photographic paper, good water resistance after printing, in particular, image storability and abrasion resistance, and recording ability to provide high density and high quality.

### SUMMARY OF THE INVENTION

In view of such a situation, the inventors have conducted extensive research and found that an aqueous ink composition which contains a hydrophilic organic solvent and a surfactant and exhibits a specific dynamic surface tension can solve the problems described above and exert excellent ink ejectibility, to thereby accomplish the present invention. More specifically, the invention provides the following.

A first aspect of the invention is an aqueous ink composition which comprises a hydrophilic organic solvent, a surfactant, and a colored fine particle dispersion which contains an oil-soluble dye, and exhibits a dynamic surface tension of 25 to 35 mN/m.

A second aspect of the invention is an ink-jet recording method which comprises a step of carrying out recording using an aqueous ink composition that includes a hydrophilic organic solvent, a surfactant, and a colored fine particle dispersion containing an oil-soluble dye, and exhibits a dynamic surface tension of 25 to 35 mN/m.

### DETAILED DESCRIPTION OF THE INVENTION

An ink composition and ink-jet recording method according to the present invention will now be described below.

(Ink Composition)

The ink composition of the present invention comprises a hydrophilic organic solvent, a surfactant, and a colored fine particle dispersion containing at least an oil-soluble dye, and exhibits a dynamic surface tension of 25 to 35 mN/m.

The surfactant is contained in the aqueous ink composition in an amount of preferably 0.5 to 5% by mass.

The oil-soluble dye preferably contains at least one compound selected from the group consisting of a compound represented by formula (I), a compound represented by formula (II), a compound represented by formula (Y-I), a compound represented by formula (M-I) and a compound represented by formula (C-I), as shown below.

The colored fine particles refer to fine particles of an oil-soluble dye itself or fine particles containing at least one kind of oil-soluble dye and at least one kind of oil-soluble polymer. The oil-soluble dye and the oil-soluble polymer may be prepared by any method insofar as they are compatible with each other.

<Oil-Soluble Dye>

The oil-soluble dye to be contained in the colored fine particles will be described below.

The oil-soluble dye, for use as one of the components constituting the colored fine particles of the invention, means a dye which is substantially insoluble in water. Specifically, the oil-soluble dye is a dye whose solubility in water at 25° C. (an amount of the dye which dissolves in 100 g of water) is 1 g or less, preferably 0.5 g or less, and more preferably 0.1 g or less.

Accordingly, the oil-soluble dye means a so-called oil-soluble dye which is insoluble in water.

The oil-soluble dye has a melting point preferably of 200° C. or less, more preferably of 150° C. or less, and still more preferably of 100° C. or less. Use of the oil-soluble dye having a lower melting point contributes to suppress crystallization of the dye in the ink composition, thus improving the storability of the ink composition.

In the ink composition of the invention, one or more kinds of oil-soluble dyes may be used. Further, coloring agents such as other water-soluble dyes, disperse dyes and pigments may be contained, as necessary, insofar as the effects of the invention are not adversely affected.

The oil-soluble dye usable in the ink composition of the invention includes, for example, an anthraquinone-type, naphthoquinone-type, styryl-type, indoaniline-type, azo-type, nitro-type, coumarin-type, methine-type, porphyrin-type, azaporphyrin-type and phthalocyanine-type dyes. Usually, in order to achieve a full-color ink-jet ink printing, at least four dyes, i.e., yellow (Y), magenta (M) and cyan (C) as three primary colors, plus black are necessary.

Among the oil-soluble dyes usable in the invention, arbitrary dyes may be used as the yellow dye. Examples thereof include aryl or heteryl azo dyes having phenols, naphthols, anilines, pyrazolones, pyridones, or open-chain type active methylene compounds as the coupling component; azomethine dyes having open-chain type active methylene compounds as the coupling component; methine dyes such as benzylidene dye and monomethine oxonol dye; quinone dyes such as naphthoquinone dye and anthraquinone dye. Other examples of the dye include quinophthalone dyes, nitro/nitroso dyes, acridine dyes and acridinone dyes.

Among the oil-soluble dyes usable in the invention, arbitrary dyes may be used as the magenta dye. Examples thereof include aryl or heteryl azo dyes having phenols, naphthols or anilines as the coupling component; azomethine dyes having pyrazolones or pyrazolotriazoles as the coupling component; methine dyes such as arylidene dye, styryl dye, merocyanine dye and oxonol dye; carbonium dyes such as diphenylmethane dye, triphenylmethane dye and xanthene dye, and quinone dyes such as naphthoquinone, anthraquinone and anthrapyridone, and condensed polycyclic dyes such as dioxazine dye.

Among the oil-soluble dyes usable in the invention, arbitrary dyes may be used as the cyan dye. Examples thereof include indoaniline dyes, indophenol dyes, or azomethine dyes having pyrrolotriazoles as the coupling component; polymethine dyes such as cyanine dye, oxonol dye and merocyanine dye; carbonium dyes such as diphenylmethane dye, triphenylmethane dye and xanthene dye; phthalocyanine dyes; anthraquinone dyes; aryl or heteryl azo dyes having phenols, naphthols or anilines as the coupling component, and indigo/thioindigo dyes.

The above-mentioned dyes may be those that develop respective colors, i.e., yellow, magenta and cyan, upon partly dissociation of their chromophore, in which a counter cation may be an inorganic cation such as alkali metal or ammonium, or an organic cation such as pyridinium or quaternary ammonium salt, or a polymer cation having such a cation as a partial moiety.

Specific examples of the oil-soluble dye are shown below, however, the invention is not limited thereto.

Preferable examples include C. I. Solvent Black 3, 7, 27, 29 and 34; C. I. Solvent Yellow 14, 16, 19, 29, 30, 56, 82, 93 and 162; C. I. Solvent Red 1, 3, 8, 18, 24, 27, 43, 49, 51, 72, 73, 109, 122, 132 and 218; C. I. Solvent Violet 3; C. I. Solvent Blue 2, 11, 25, 35, 38, 67 and 70; C. I.

Solvent Green 3 and 7; and C. I. Solvent Orange 2.

More specifically, preferable examples of the dye are Nubian Black PC-0850, Oil Black HBB, Oil Yellow 129, Oil yellow 105, Oil Pink 312, Oil Red 5B, Oil Scarlet 308, Vali Fast Blue 2606, Oil Blue BOS (Orient Chemical Industries, Ltd.), Aizen Spilon Blue GNH (Hodogaya Chemical Co., Ltd.), Neopen Yellow 075, Neopen Mazenta SE 1378, Neopen Blue 808, Neopen Blue FF4012, Neopen Cyan FF4238 (BASF, Ltd.), etc.

In the invention, a disperse dye may be used insofar as it is soluble in a water-immiscible organic solvent, and specific examples thereof are shown below, however, the invention is not limited thereto.

Preferable examples include C. I. Disperse Yellow 5, 42, 54, 64, 79, 82, 83, 93, 99, 100, 119, 122, 124, 126, 160, 184:1, 186, 198, 199, 201, 204, 224 and 237; C. I. Disperse Orange 13, 29, 31:1, 33, 49, 54, 55, 66, 73, 118, 119 and 163; C. I. Disperse Red 54, 60, 72, 73, 86, 88, 91, 92, 93, 111, 126, 127, 134, 135, 143, 145, 152, 153, 154, 159, 164, 167:1, 177, 181, 204, 206, 207, 221, 239, 240, 258, 277, 278, 283, 311, 323, 343, 348, 356 and 362; C. I. Disperse Violet 33; C. I. Disperse Blue 56, 60, 73, 87, 113, 128, 143, 148, 154, 158, 165, 165:1, 165:2, 176, 183, 185, 197, 198, 201, 214, 224, 225, 257, 266, 267, 287, 354, 358, 365 and 368; and C. I. Disperse Green 6:1 and 9.

More specifically, preferable examples of the oil-soluble dye are the compounds (azo dyes) represented by formula (I) and the compounds (azomethine dyes) represented by formula (II), shown below. In the field of photographic materials, the azomethine dyes represented by formula (II) are known as the dye formed by oxidation of a developing agent and a coupler.

Description will now be given of the compounds represented by formulae (I) and (II). The compounds represented by formulae (I) and (II) are preferably those wherein at least one group, preferably two or more groups, more preferably all groups carried therein are selected from those shown below.

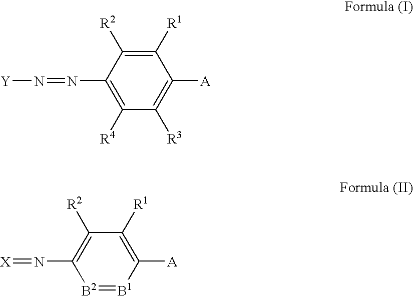

In formulae (I) and (II), R¹, R², R³ and R⁴ each independently represent a hydrogen atom, halogen atom, aliphatic group, aromatic group, heterocyclic group, cyano group, hydroxy group, nitro group, amino group, alkylamino group, alkoxy group, aryloxy group, amide group, arylamino group, ureido group, sulfamoylamino group, alkylthio group, arylthio group, alkoxycarbonylamino group, sulfonamide group, carbamoyl group, sulfamoyl group, sulfonyl group, alkoxycarbonyl group, heterocyclic oxy group, azo group, acyloxy group, carbamoyloxy group, silyloxy group, aryloxycarbonyl group, aryloxycarbonylamino group, imide group, heterocyclic thio group, sulfinyl group, phosphoryl group, acyl group, carboxyl group or sulfo group.

Among these, R² is preferably a hydrogen atom, halogen atom, aliphatic group, alkoxy group, aryloxy group, amide group, ureido group, sulfamoylamino group, alkoxycarbonylamino group or sulfonamide group.

In formulae (I) and (II), A represents —NR⁵R⁶ or a hydroxy group. A is preferably —NR⁵R⁶.

The above-mentioned R⁵ and R⁶ each independently represent a hydrogen atom, aliphatic group, aromatic group or heterocyclic group. More preferably, R⁵ and R⁶ each independently represent a hydrogen atom, alkyl group or substituted alkyl group, aryl group or substituted aryl group, and most preferably, a hydrogen atom, C₁₋₁₈ alkyl group or substituted C₁₋₁₈ alkyl group. R⁵ and R⁶ may be connected to each other to form a ring.

In formula (II), B¹ represents ═C(R³)— or ═N—. B² represents —C(R⁴)═ or —N═. It is preferable that B¹ and B² are not simultaneously —N═, and it is more preferable that B¹ is ═C(R³)— and B² is —C(R⁴)═.

In formulae (I) and (II), R¹ and R⁵, R³ and R⁶, and/or R¹ and R² may be connected to each other to form an aromatic or heterocyclic ring.

As used herein, the aliphatic group refers to an alkyl group, substituted alkyl group, alkenyl group, substituted alkenyl group, alkynyl group, substituted alkynyl group, aralkyl group and substituted aralkyl group.

The aliphatic group may be branched or cyclic. The number of carbon atoms in the aliphatic group is preferably 1 to 20, and more preferably 1 to 18.

The aryl moiety in the aralkyl group and in the substituted aralkyl group is preferably a phenyl or naphthyl group, with a phenyl group being more preferable.

Substituents on the alkyl moiety in the substituted alkyl group, substituted alkenyl group, substituted alkynyl group and substituted aralkyl group include the same substituents as mentioned for R¹, R², R³ and R⁴.

Substituents on the aryl moiety in the substituted aralkyl group include the same substituents to be mentioned later for the substituents on the aryl group.

As used herein, the aromatic group refers to an aryl group and substituted aryl group. The aryl group is preferably a phenyl or naphthyl group, with a phenyl group being more preferable.

The aryl moiety in the substituted aryl group is the same as in the above aryl group.

Substituents on the substituted aryl group include the same substituents as mentioned for R¹, R², R³ and R⁴.

In formula (I), Y represents an unsaturated heterocyclic group. Y is preferably a 5- or 6-membered unsaturated heterocyclic ring. An aliphatic ring, an aromatic ring or another heterocyclic ring may be condensed with the heterocyclic ring. Examples of heteroatoms in the heterocyclic ring include N, O and S.

Preferable examples of the unsaturated heterocyclic ring include a pyrazol ring, imidazole ring, thiazole ring, isothiazole ring, thiadiazole ring, thiophene ring, benzothiazole rig, benzoxazole ring, benzoisothiazole ring, pyrimidine ring, pyridine ring and quinoline ring. The unsaturated heterocyclic group may have the same substituents as mentioned for R¹ to R⁴ above.

In formula (II), X represents a moiety of a color forming coupler. Preferable examples of the coupler are set forth below:

Examples of the yellow coupler include the couplers described in U.S. Pat. Nos. 3,933,501, 4,022,620, 4,326,024, 4,401,752, 4,248,961, JP-B 58-10739, G.B. Patent Nos. 1,425,020, 1,476,760, U.S. Pat. Nos. 3,973,968, 4,314,023, 4,511,649, EP No. 249,473A, the couplers represented by Formulae (I) and (II) in EP No. 502,424A, the couplers (particularly Y-28 on page 18) represented by Formulae (1) and (2) in EP No. 513,496A, the couplers represented by Formula (I) in EP No. 568,037A, the couplers represented by Formula (I) in lines 45 to 55 at column 1 in U.S. Pat. No. 5,066,576, the couplers represented by Formula (I) at paragraph 0008 in JP-A No. 4-274425, the couplers (particularly D-35 on page 18) stated in claim 1 on page 40 in EP No. 498,381A1, the couplers (particularly Y-1 (page 17) and Y-54 (page 41)) represented by Formula (Y) on page 4 in EP No. 447,969A1, and the couplers (particularly 11-17, 19 (column 17) and 11-24 (column 19)) represented by Formulae (II) to (IV) in lines 36 to 58 at column 7 in U.S. Pat. No. 4,476,219.

Examples of the magenta coupler include those described in U.S. Pat. Nos. 4,310,619, 4,351,897, EP No. 73,636, U.S. Pat. Nos. 3,061,432, 3,725,067, Research Disclosure No. 24220 (June, 1984), Research Disclosure No. 24230 (June, 1984), JP-A Nos. 60-33552, 60-43659, 61-72238, 60-35730, 55-118034, 60-185951, U.S. Pat. Nos. 4,500,630, 4,540,654, 4,556,630, WO 88/04795, L-57 (lower right column on page 11), L-68 (lower right column on page 12) and L-77 (lower right column on page 13) in JP-A No. 3-39737, [A-4]-63 (page 134), [A-4]-73, -75 (page 139) in EP No. 456,257, M-4, -6 (page 26) and M-7 (page 27) in EP No. 486,965, M-45 (page 19) in EP No. 571,959A, (M−1) (page 6) in JP-A No. 5-204106 and M-22 in column 0237 in JP-A No. 4-362631.

Examples of the cyan coupler include those described in U.S. Pat. Nos. 4,052,212, 4,146,396,4,228,233, 4,296,200, EP No. 73,636, CX-1, 3, 4, 5, 11, 12, 14 and 15 (pages 14 to 16) in JP-A No. 4-204843, and C-7, 10 (page 35), 34, 35 (page 37), (1-1), (1-17) (pages 42 to 43) in JP-A No. 4-43345, and the couplers represented by Formula (Ia) or (Ib) in claim 1 in JP-A No. 6-67385.

Further, the couplers described in JP-A No. 62-215272 (page 91), JP-A No. 2-33144 (pages 3 and 30), and EP No. 355,660A (pages 4, 5, 45 and 47) are also useful.

Among the dyes represented by formula (I) above, dyes represented by the following formula (III) are particularly preferable as the magenta dye.

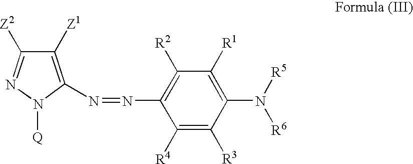

In formula (III) above, Z¹ represents an electron-withdrawing group having a Hammett's substituent constant σₚ value of 0.20 or more. Z¹ is preferably an electron-withdrawing group having a σp value of 0.30 to 1.0. Preferable examples of the substituent include electron-withdrawing substituent groups to be described later, among which a C₂₋₁₂ acyl group, C₂₋₁₂ alkyloxycarbonyl group, nitro group, cyano group, C₁₋₁₂ alkylsulfonyl group, C₆₋₁₈ arylsulfonyl group, C₁₋₁₂ carbamoyl group and C₁₋₁₂ halogenated alkyl group are preferable, and a cyano group, C₁₋₁₂ alkylsulfonyl group and C₆₋₁₈ arylsulfonyl group are more preferable, with a cyano group being most preferable.

R¹ to R⁶ have the same meanings as defined in formula (I) above.

Z² represents a hydrogen atom, aliphatic group or aromatic group.

Q represents a hydrogen atom, aliphatic group, aromatic group or heterocyclic group. In particular, Q is preferably a group consisting of non-metal atoms necessary for forming a 5- to 8-membered ring, and more preferably an aromatic group or heterocyclic group. The 5- to 8-membered ring may have a substituent, or it may be a saturated ring or may have an unsaturated bond. The non-metal atom is preferably a nitrogen atom, oxygen atom, sulfur atom or carbon atom.

Suitable examples of the 5- to 8-membered ring include a benzene ring, cyclopentane ring, cyclohexane ring, cycloheptane ring, cyclooctane ring, cyclohexene ring, pyridine ring, pyrimidine ring, pyrazine ring, pyridazine ring, triazine ring, imidazole ring, benzimidazole ring, oxazole ring, benzoxazole ring, oxane ring, sulfolane ring and thiane ring. When these groups further have substituents, the substituents are preferably those as exemplified for R¹ to R⁴ above.

Preferable structures of the dyes represented by formula (III) above are shown in Japanese Patent Application No. 2000-220649.

Among the dyes represented by formula (II) above, the dyes represented by the following formula (IV) are particularly preferable as the magenta dye:

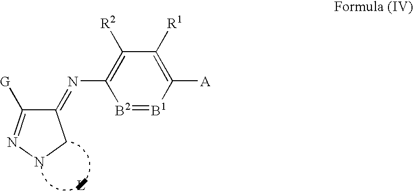

wherein G represents a hydrogen atom, aliphatic group, aromatic group, heterocyclic group, cyano group, alkoxy group, aryloxy group, alkylthio group, arylthio group, ester group, amino group, carbamoyl group, sulfonyl group, sulfamoyl group, ureido group, urethane group, acyl group, amide group or sulfonamide group;

R¹, R², A, B¹ and B² have the same meanings as defined in formula (II) above, and preferable substituents are also the same as in formula (II) above; and

L represents a group of atoms for forming a 5- to 6-membered nitrogen-containing heterocyclic ring, and the group of atoms for forming the 5- to 6-membered nitrogen-containing heterocyclic ring may be substituted with at least one substituent selected from an aliphatic group, aromatic group, heterocyclic group, cyano group, alkoxy group, aryl group, oxy group, alkylthio group, arylthio group, ester group, amino group, carbamoyl group, sulfonyl group, sulfamoyl group, ureido group, urethane group, acyl group, amide group and sulfonamide group, or may form a condensed ring with another ring.

In the dyes represented by formula (IV), A is preferably —NR⁵R⁶, and L preferably forms a 5-membered nitrogen-containing heterocyclic ring. Preferable examples of the 5-membered nitrogen-containing heterocyclic ring include an imidazole ring, triazole ring and tetrazole ring.

Among the dyes represented by formulae (I) and (II), exemplary compounds of the magenta dyes are described in paragraphs [0068] to [0085] in Japanese Patent Application No. 2002-10361, but the invention is not limited thereto. The compounds usable in the invention include, but are not limited to, the exemplary compounds described above and those described in Japanese Patent Application Nos. 11-365187, 11-365190, and 2000-220649.

The dyes represented by formula (III) in the present invention can be synthesized referring to the methods described, for example, in Japanese Patent Application No. 2000-220649 and JP-A No. 55-161856.

The dyes represented by formula (IV) in the invention can be synthesized on the basis of methods described in, for example, JP-A No. 4-126772, JP-B No.7-94180 and Japanese Patent Application No. 2000-78491.

Among the dyes represented by formula (II) above, pyrrolotriazole azomethine dyes represented by the following formula (V) are particularly preferable as the cyan dye.

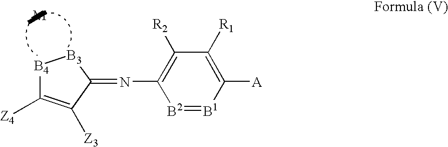

wherein A, R¹, R², B¹ and B² have the same meanings as defined in formula (II) above, and preferable substituents are also the same as in formula (II) above,

Z³ and Z⁴ each independently have the same meaning as for G in formula (IV) above, and Z³ and Z⁴ may be connected to each other to form a cyclic structure; and

M is an atomic group capable of forming a 1,2,4-triazole ring condensed with the 5-membered ring of formula (V) above, in which either one of B³ and B⁴ is a nitrogen atom and the other is a carbon atom.

In the pyrrolotriazole azomethine dyes represented by formula (V) above, Z³ is an electron-withdrawing group having a Hammett's substituent constant σₚ value of preferably 0.30 or more, more preferably 0.45 or more, and still more preferably 0.60 or more, to exhibit sharp absorption.

The cyan dyes having the sum of Hammett's substituent constant σₚ value for Z³ and Z⁴ over 0.70 exhibit an excellent hue as the cyan color.

The pyrrolotriazole azomethine dye represented by formula (V) above may be used as the magenta dye by changing its substituent, but its use as the cyan dye is preferable.

The Hammett's substituent constant σₚ value as used herein is described below.

The Hammett's rule is an empirical rule proposed by L. P. Hammett in 1935 to quantitatively discuss the influence of substituents on the reaction or equilibrium of benzene derivatives, and at present this rule is generally recognized valid.

The substituent constant in the Hammett's rule includes σₚ value and σₘ value, and these values appear in many books and are detailed, for example, in Lange's Handbook of Chemistry, 12th Ed. (1979), edited by J. A. Dean (McGraw-Hill), and Region of Chemistry (in Japanese), Extra Issue, No. 122, pp. 96-103 (1979), Nankodo.

In the invention, the respective substituents are limited as described by the Hammett's constant σₚ value, but this does not mean that the substituents are limited only to those having known values found in the above books, but means that the substituents encompass those having Hammett's constant σₚ values which when measured according to the Hammett's rule, are within a range specified in the invention even if their values are not known.

The compounds represented by formulae (I) to (V) in the invention cover the compounds that are not benzene derivatives, however, the σₚ value is used regardless of the substituent position as a criterion indicative of the electron effect of the substituent. As used herein, the σₚ value has such a meaning.

The electron-withdrawing group having a Hammett's substituent constant σₚ value of 0.60 or more includes a cyano group, nitro group, alkylsulfonyl group (e.g., a methanesulfonyl group), an arylsulfonyl group (e.g., a benzenesulfonyl group), etc.

The electron-withdrawing group having a Hammett's substituent constant σₚ value of 0.45 or more includes those described above, and additionally, an acyl group (e.g., an acetyl group), an alkoxycarbonyl group (e.g., a dodecyloxycarbonyl group), an aryloxycarbonyl group (e.g., m-chlorophenoxycarbonyl), an alkylsulfinyl group (e.g., n-propylsulfinyl), an arylsulfinyl group (e.g., phenylsulfinyl), a sulfamoyl group (e.g., N-ethylsulfamoyl, N,N-dimethylsulfamoyl), a halogenated alkyl group (e.g., trifluoromethyl), etc.

The electron-withdrawing group having a Hammett's substituent constant σₚ value of 0.30 or more includes those described above, and additionally, an acyloxy group (e.g., acetoxy), a carbamoyl group (e.g., N-ethylcarbamoyl, N,N-dibutylcarbamoyl), a halogenated alkoxy group (e.g., trifluoromethyloxy), a halogenated alyloxy group (e.g., pentafluorophenyloxy), a sulfonyloxy group (e.g., a methylsulfonyloxy group), a halogenated alkylthio group (e.g., difluoromethylthio), an aryl group substituted with two or more electron-withdrawing groups each having a Hammett's substituent constant σₚ value of 0.15 or more (e.g., 2,4-dinitrophenyl, pentachlorophenyl), and a heterocyclic ring (e.g., 2-benzoxazolyl, 2-benzothiazolyl, 1-phenyl-2-benzimidazolyl), etc.

The electron-withdrawing group having a Hammett's substituent constant σₚ value of 0.20 or more includes those described above and halogen atoms.

Among the pyrrolotriazole azomethine dyes for use in the invention, exemplary compounds (C-1 to C-9) as the cyan dye are shown in paragraphs [0100] to [0102] in Japanese Patent Application 2002-10361, however, the invention is not limited thereto.

The dyes usable in the invention also include exemplary compounds described in Japanese Patent Application No. 11-365188, however, the invention is not limited thereto.

The yellow dye as the oil-soluble dye for use in the invention is preferably a compound (dye) represented by the following formula (Y-I):

A−N=N−B Formula (Y-I)

wherein A and B each independently represent an optionally substituted heterocyclic group.

The heterocyclic group is preferably a heterocyclic group composed of a 5- or 6-membered ring. It may be a monocyclic structure or a polycyclic structure having two or more rings condensed therein, and may be an aromatic or non-aromatic heterocyclic ring. A heteroatom constituting the heterocyclic ring is preferably a nitrogen atom, oxygen atom or sulfur atom.

In formula (Y-I) above, the heterocyclic ring represented by A is preferably 5-pyrazolone, pyrazole, oxazolone, isoxazolone, barbituric acid, pyridone, rhodanine, pyrazolidinedione, pyrazolopyridone, meldrum's acid or a condensed heterocyclic ring having a hydrocarbon aromatic ring or a heterocyclic ring condensed therewith. The heterocyclic ring is preferably 5-pyrazolone, 5-aminopyrazole, pyridone or pyrazoloazole, and more preferably 5-aminopyrazole, 2-hydroxy-6-pyridone or pyrazolotriazole.

The heterocyclic ring represented by B in formula (Y-I) above is preferably pyridine, pyrazine, pyrimidine, pyridazine, triazine, quinoline, isoquinoline, quinazoline, cinnoline, phthalazine, quinoxaline, pyrrole, indole, furan, benzofuran, thiophene, benzothiophene, pyrazole, imidazole, benzimidazole, triazole, oxazole, isoxazole, benzoxazole, thiazole, benzothiazole, isothiazole, benzisothiazole, thiadiazole, benzisoxazole, pyrrolidine, piperidine, piperazine, imidazolidine and thiazoline. The heterocyclic ring is more preferably pyridine, quinoline, thiophene, benzothiophene, pyrazole, imidazole, benzimidazole, triazole, oxazole, isoxazole, benzoxazole, thiazole, benzothiazole, isothiazole, benzisothiazole, thiadiazole or benzisoxazole, still more preferably quinoline, thiophene, pyrazole, thiazole, benzoxazole, benzisoxazole, isothiazole, imidazole, benzothiazole or thiadiazole, and further still more preferably pyrazole, benzothiazole, benzoxazole, imidazole, 1,2,4-thiadiazole or 1,3,4-thiadiazole.

Examples of substituents on the above A and B include a halogen atom, alkyl group, cycloalkyl group, aralkyl group, alkenyl group, alkynyl group, aryl group, heterocyclic group, cyano group, hydroxyl group, nitro group, alkoxy group, aryloxy group, silyloxy group, heterocyclic oxy group, acyloxy group, carbamoyloxy group, alkoxycarbonyloxy group, aryloxycarbonyloxy, amino group, acylamino group, aminocarbonylamino group, alkoxycarbonylamino group, aryloxycarbonylamino group, sulfamoylamino group, alkyl and arylsulfonylamino group, mercapto group, alkylthio group, arylthio group, heterocyclic thio group, sulfamoyl group, alkyl and arylsulfinyl group, alkyl and arylsulfonyl group, acyl group, aryloxycarbonyl group, alkoxycarbonyl group, carbamoyl group, imide group, phosphino group, phosphinyl group, phosphinyloxy group, phosphinylamino group, and silyl group.

The dyes represented by formula (Y-I) are more preferably the dyes represented by formulae (Y-II), (Y-III) and (Y-IV), shown below.

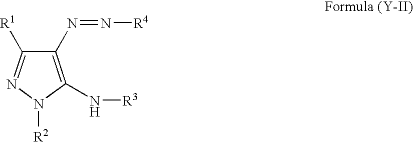

In formula (Y-II), R¹ and R³ each represent a hydrogen atom, cyano group, alkyl group, cycloalkyl group, aralkyl group, alkoxy group, alkylthio group, arylthio group, aryl group or ionic hydrophilic group. R² represents a hydrogen atom, alkyl group, cycloalkyl group, aralkyl group, carbamoyl group, acyl group, aryl group or heterocyclic group. R⁴ represents a heterocyclic group.

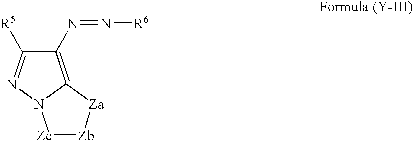

In formula (Y-III), R⁵ represents a hydrogen atom, cyano group, alkyl group, cycloalkyl group, aralkyl group, alkoxy group, alkylthio group, arylthio group, aryl group or ionic hydrophilic group. Za represents —N═, —NH—, or C(R¹¹)═, and Zb and Zc each independently represent —N=or C(R¹¹)═, and R¹¹ represents a hydrogen atom or a non-metal substituent group. R⁶ represents a heterocyclic group.

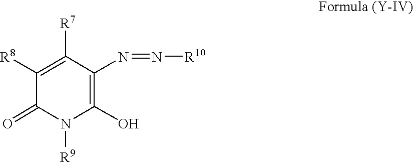

In formula (Y-IV), R⁷ and R⁸ each independently represent a hydrogen atom, cyano group, alkyl group, cycloalkyl group, aralkyl group, aryl group, alkylthio group, arylthio group, alkoxycarbonyl group, carbamoyl group or ionic hydrophilic group. R⁸ represents a hydrogen atom, halogen atom, alkyl group, alkoxy group, aryl group, aryloxy group, cyano group, acylamino group, sulfonylamino group, alkoxycarbonylamino group, ureido group, alkylthio group, arylthio group, alkoxycarbonyl group, carbamoyl group, sulfamoyl group, sulfonyl group, acyl group, alkylamino group, arylamino group, hydroxy group or ionic hydrophilic group. R¹⁰ represents a heterocyclic group.

Hereinafter, the substituents represented by R¹, R², R³, R⁵, R⁷, R⁸ and R⁹ in formulae (Y-II), (Y-III) and (Y-IV) are described in more detail.

The alkyl group represented by R¹, R², R³, R⁵, R⁷, R⁸ and R⁹ includes an alkyl group having a substituent and an unsubstituted alkyl group.

The alkyl group is preferably a C₁₋₂₀ alkyl group, and examples of the substituent include a hydroxyl group, alkoxy group, cyano group, halogen atom and ionic hydrophilic group.

Preferable examples of the alkyl group include methyl, ethyl, butyl, isopropyl, t-butyl, hydroxyethyl, methoxyethyl, cyanoethyl, trifluoromethyl, 3-sulfopropyl and 4-sulfobutyl.

The cycloalkyl group represented by R¹, R², R³, R⁵, R⁷, R⁸ and R⁹ includes a cycloalkyl group having a substituent and an unsubstituted cycloalkyl group.

The cycloalkyl group is preferably a C₅₋₁₂ cycloalkyl group, and examples of the substituent group include an ionic hydrophilic group.

Preferable examples of the cycloalkyl group include cyclohexyl.

The aralkyl group represented by R¹, R², R³, R⁵, R⁷, R⁸ and R⁹ includes an aralkyl group having a substituent and an unsubstituted aralkyl group.

The aralkyl group is preferably a C₇₋₂₀ aralkyl group, and examples of the substituent include an ionic hydrophilic group.

Preferable examples of the aralkyl group include benzyl and 2-phenethyl.

The aryl group represented by R¹, R², R³, R⁵, R⁷ and R⁹ includes an aryl group having a substituent and an unsubstituted aryl group.

The aryl group is preferably a C₆₋₂₀ aryl group, and examples of the substituent include an alkyl group, alkoxy group, halogen atom, alkylamino group and ionic hydrophilic group.

Preferable examples of the aryl group include phenyl, p-tolyl, p-methoxyphenyl, o-chlorophenyl, and m-(3-sulfopropylamino)phenyl.

The alkylthio group represented by R¹, R², R³, R⁵, R⁷, R⁸ and R⁹ includes an alkylthio group having a substituent and an unsubstituted alkylthio group.

The alkylthio group is preferably a C₁₋₂₀ alkylthio group, and examples of the substituent include an ionic hydrophilic group.

Preferable examples of the alkylthio group include methylthio and ethylthio.

The arylthio group represented by R¹, R², R³, R⁵, R⁷, R⁸ and R⁹ includes an arylthio group having a substituent and an unsubstituted arylthio group.

The arylthio group is preferably a C₆₋₂₀ arylthio group, and examples of the substituent include an alkyl group and ionic hydrophilic group.

Preferable examples of the arylthio group include phenylthio and p-tolylthio.

The heterocyclic group represented by R² is preferably a 5- or 6-membered heterocyclic ring which may further be condensed. The heteroatom constituting the heterocyclic ring is preferably a nitrogen atom, sulfur atom or oxygen atom. The heterocyclic group may be an aromatic or non-aromatic heterocyclic ring. The heterocyclic ring may be further substituted, and examples of the substituent include the same substituent as on the aryl group to be described later. The heterocyclic ring is preferably a 6-membered nitrogen-containing aromatic heterocyclic ring, particularly preferably triazine, pyrimidine or phthalazine.

Preferable examples of the halogen atom represented by R⁸ include a fluorine atom, chlorine atom and bromine atom.

The alkoxy group represented by R¹, R³, R⁵ and R⁸ includes an alkoxy group having a substituent and an unsubstituted alkoxy group.

The alkoxy group is preferably a C₁₋₂₀ alkoxy group, and examples of the substituent include a hydroxyl group and ionic hydrophilic group.

Preferable examples of the alkoxy group include methoxy, ethoxy, isopropoxy, methoxyethoxy, hydroxyethoxy, and 3-carboxypropoxy.

The aryloxy group represented by R⁸ includes an aryloxy group having a substituent and an unsubstituted aryloxy group.

The aryloxy group is preferably a C₆₋₂₀ aryloxy group, and examples of the substituent include an alkoxy group and ionic hydrophilic group.

Preferable examples of the aryloxy group include phenoxy, p-methoxyphenoxy and o-methoxyphenoxy.

The acylamino group represented by R⁸ includes an acylamino group having a substituent and an unsubstituted acylamino group.

The acylamino group is preferably a C₂₋₂₀ acylamino group, and examples of the substituent include an ionic hydrophilic group.

Preferable examples of the acylamino group include acetamide, propionamide, benzamide and 3,5-disulfobenzamide.

The sulfonylamino group represented by R⁸ includes a sulfonylamino group having a substituent and an unsubstituted sulfonylamino group.

The sulfonylamino group is preferably a C₁₋₂₀ sulfonylamino group.

Preferable examples of the sulfonylamino group include methylsulfonylamino and ethylsulfonylamino.

The alkoxycarbonylamino group represented by R⁸ includes an alkoxycarbonylamino group having a substituent and an unsubstituted alkoxycarbonylamino group.

The alkoxycarbonylamino group is preferably a C₂₋₂₀ alkoxycarbonylamino group, and examples of the substituent include an ionic hydrophilic group.

Preferable examples of the alkoxycarbonylamino group include ethoxycarbonylamino.

The ureido group represented by R⁸ includes an ureido group having a substituent and an unsubstituted ureido group.

The ureido group is preferably a C₁₋₂₀ ureido group, and examples of the substituent include an alkyl group and aryl group.

Preferable examples of the ureido group include 3-methylureido, 3,3-dimethylureido and 3-phenylureido.

The alkoxycarbonyl group represented by R⁷, R⁸ and R⁹ includes an alkoxycarbonyl group having a substituent and an unsubstituted alkoxycarbonyl group.

The alkoxycarbonyl group is preferably a C₂₋₂₀ alkoxycarbonyl group, and examples of the substituent include an ionic hydrophilic group.

Preferable examples of the alkoxycarbonyl group include methoxycarbonyl and ethoxycarbonyl.

The carbamoyl group represented by R², R⁷, R⁸ and R⁹ includes a carbamoyl group having a substituent and an unsubstituted carbamoyl group. Examples of the substituent include an alkyl group.

Preferable examples of the carbamoyl group include a methylcarbamoyl group and dimethylcarbamoyl group.

The sulfamoyl group represented by R⁵ includes a sulfamoyl group having a substituent and an unsubstituted sulfamoyl group. Examples of the substituent include an alkyl group.

Preferable examples of the sulfamoyl group include a dimethylsulfamoyl and di-(2-hydroxyethyl)sulfamoyl group.

Preferable examples of the sulfonyl group represented by R⁸ include methanesulfonyl and phenylsulfonyl.

The acyl group represented by R² and R⁸ includes an acyl group having a substituent and an unsubstituted acyl group. The acyl group is preferably a C₁₋₂₀ acyl group, and examples of the substituent include an ionic hydrophilic group.

The acyl group is preferably acetyl or benzoyl.

The amino group represented by R⁸ includes an amino group having a substituent and an unsubstituted amino group. Examples of the substituent include an alkyl group, aryl group and heterocyclic group.

Preferable examples of the amino group include methylamino, diethylamino, anilino and 2-chloroanilino.

The heterocyclic group represented by R⁴, R⁶ and R¹⁰ is the same as the optionally substituted heterocyclic group represented by B in formula (Y-I) above, and preferable examples, more preferable examples and still more preferable examples thereof are the same as those exemplified above.

The substituent includes an ionic hydrophilic group, C₁₋₁₂ alkyl group, aryl group, alkyl or arylthio group, halogen atom, cyano group, sulfamoyl group, sulfonamino group, carbamoyl group, acylamino group, etc., and the alkyl group and aryl group may further have a substituent.

In formula (Y-III) above, Za represents —N═, —NH—, or C(R¹¹)═. Zb and Zc each independently represent —N═or C(R¹¹)═. R¹¹ represents a hydrogen atom or a non-metal substituent. The non-metal substituent represented by R¹¹ is preferably a cyano group, cycloalkyl group, aralkyl group, aryl group, alkylthio group, arylthio group or ionic hydrophilic group. The respective substituents have the same meanings as those of the respective substituents represented by R¹, and preferable examples thereof are the same as those exemplified above. Examples of the skeleton of the heterocyclic ring composed of two 5-membered rings contained in formula (Y-III) above are shown below.

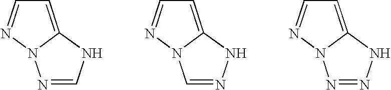

When the respective substituents described above may further have substituents, examples thereof include the substituents which may substitute on the heterocyclic rings A and B in formula (Y-I).

Examples of dyes (Y-101 to Y-155) represented by formula (Y-I) are shown in paragraphs [0139] to [0149] in Japanese Patent Application No. 2002-10361, however, the dyes for use in the invention are not limited to the exemplary compounds shown later. These compounds may be synthesized by referring to JP-A Nos. 2-24191 and 2001-279145.

The oil-soluble dye suitably used as the oil-soluble dye in the invention is preferably a compound represented by the following formula (M-I) (hereinafter sometimes referred to as “azo dye”). Hereinafter, the compound represented by formula (M-I) of the invention is described.

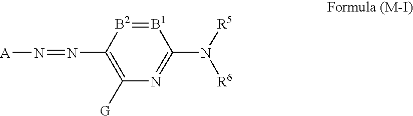

In formula (M−1), A represents a moiety of a diazo component A-NH₂ in the 5-membered heterocyclic ring.

With respect to B¹ and B², B¹ represents ═CR¹— and B² represents —CR²═, or alternatively, either one represents a nitrogen atom and the other represents ═CR¹— or —CR²═.

R⁵ and R⁶ each independently represent a hydrogen atom, aliphatic group, aromatic group, heterocyclic group, acyl group, alkoxycarbonyl group, aryloxycarbonyl group, carbamoyl group, alkylsulfonyl group, arylsulfonyl group or sulfamoyl group. Each group may further have a substituent.

G, R¹ and R² each independently represent a hydrogen atom, halogen atom, aliphatic group, aromatic group, heterocyclic group, cyano group, carboxyl group, carbamoyl group, alkoxycarbonyl group, aryloxycarbonyl group, acyl group, hydroxy group, alkoxy group, aryloxy group, silyloxy group, acyloxy group, carbamoyloxy group, heterocyclic oxy group, alkoxycarbonyloxy group, aryloxycarbonyloxy group, amino group substituted with an alkyl, aryl or heterocyclic group, acylamino group, ureido group, sulfamoylamino group, alkoxycarbonylamino group, aryloxycarbonylamino group, alkylarylsulfonylamino group, arylsulfonylamino group, aryloxycarbonylamino group, nitro group, alkylthio group, arylthio group, alkylsulfonyl group, arylsulfonyl group, alkylsulfinyl group, arylsulfinyl group, sulfamoyl group, sulfo group or heterocyclic thio group. Each group may further have a substituent.

Furthermore, R¹ and R⁵, or R⁵ and R⁶ may be connected to each other to form a 5- to 6-membered ring.

Hereinafter, the compound represented by formula (M-I) in the invention is described in more detail.

In formula (M-I), A represents a moiety of a diazo component A-NH₂ in the 5-membered heterocyclic ring. Examples of the heteroatom in the 5-membered heterocyclic ring include N, O and S. The ring is preferably a nitrogen-containing 5-membered heterocyclic ring with which an aliphatic ring, aromatic rig or another heterocyclic ring may be condensed.

Preferable examples of the heterocyclic group of A include a pyrazole ring, imidazole ring, thiazole ring, isothiazole ring, thiadiazole ring, benzothiazole ring, benzoxazole ring and benzisothiazole ring. Each heterocyclic group may further have a substituent. Particularly, the pyrazol ring, imidazole ring, isothiazole ring, thiadiazole ring and benzothiazole ring represented by formulae (M-a) to (M-f) shown blow are preferable.

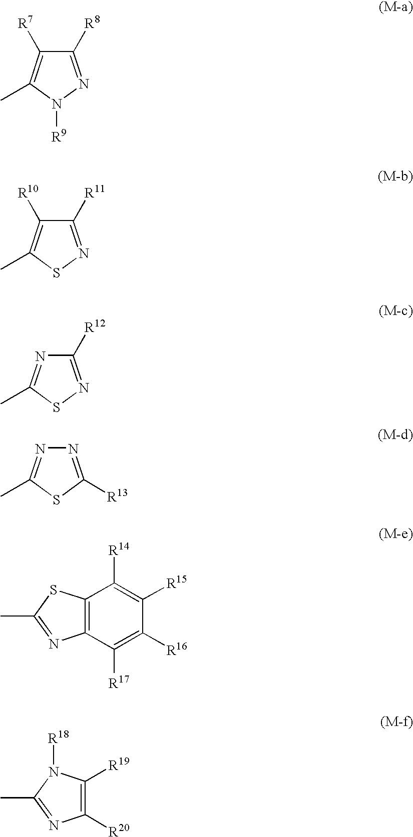

R⁷ to R²⁰ in formulae (M-a) to (M-f), shown above, represent the same substituent as the substituents G, R¹ and R² to be described later.

The heterocyclic groups represented by formulae (M-a) to (M-f) are preferably a pyrazol ring and isothiazole ring represented by formulae (M-a) and (M-b), most preferably is a pyrazol ring represented by formula (M-a).

With respect to B¹ and B², B¹ represents ═CR¹— while B² represents —CR²═, or alternatively, either one represents a nitrogen atom while the other represents ═CR¹— or —CR²═, and more preferably B¹ represents ═CR¹— while B² represents —CR²═.

R¹ and R⁶ each independently represent a hydrogen atom, aliphatic group, aromatic group, heterocyclic group, acyl group, alkoxycarbonyl group, aryloxycarbonyl group, carbamoyl group, alkylsulfonyl group, arylsulfonyl group, or sulfamoyl group, and each group may further have a substituent. Preferable examples of the substituent represented by R⁵ and R⁶ include a hydrogen atom, aliphatic group, aromatic group, heterocyclic group, acyl group, alkylsulfonyl group, and arylsulfonyl group. The substituent is more preferably a hydrogen atom, aromatic group, heterocyclic group, acyl group, alkylsulfonyl group or arylsulfonyl group. The substituent is most preferably a hydrogen atom, aryl group or heterocyclic group. Each group may further have a substituent. However, R⁵ and R⁶ are not simultaneously hydrogen atoms.

G, R¹ and R² each independently represent a hydrogen atom, halogen atom, aliphatic group, aromatic group, heterocyclic group, cyano group, carboxyl group, carbamoyl group, alkoxycarbonyl group, aryloxycarbonyl group, acyl group, hydroxy group, alkoxy group, aryloxy group, silyloxy group, acyloxy group, carbamoyloxy group, heterocyclic oxy group, alkoxycarbonyloxy group, aryloxycarbonyloxy group, amino group substituted with an alkyl, aryl or heterocyclic group, acylamino group, ureido group, sulfamoylamino group, alkoxycarbonylamino group, aryloxycarbonylamino group, alkylsulfonylamino group, arylsulfonylamino group, nitro group, alkylthio group, arylthio group, heterocyclic thio group, alkylsulfonyl group, arylsulfonyl group, alkylsulfinyl group, arylsulfinyl group, sulfamoyl group or sulfo group, and each group may further have a substituent.

The substituent represented by G is preferably a hydrogen atom, halogen atom, aliphatic group, aromatic group, hydroxy group, alkoxy group, aryloxy group, acyloxy group, heterocyclic oxy group, amino group substituted with an alkyl, aryl or heterocyclic group, acylamino group, ureido group, sulfamoylamino group, alkoxycarbonylamino group, aryloxycarbonylamino group, alkylthio group, arylthio group and heterocyclic thio group, more preferably a hydrogen atom, halogen atom, alkyl group, hydroxy group, alkoxy group, aryloxy group, acyloxy group, amino group substituted with an alkyl, aryl or heterocyclic group, or acylamino group, and most preferably a hydrogen atom, arylamino group or amide group. Each group may further have a substituent.

Preferable examples of the substituent represented by R¹ and R² include a hydrogen atom, alkyl group, alkoxycarbonyl group, carboxyl group, carbamoyl group and cyano group. Each group may further have a substituent.

R¹ and R⁵, or R⁵ and R⁶ may be connected to each other to form a 5- to 6-membered ring.

When the respective substituents represented by A, R¹, R², R⁵, R⁶ and G further have substituents, the additional substituents include the substituents exemplified for G, R¹, and R² above.

Hereinafter, the substituents represented by G, R¹ and R² are described in more detail.

The halogen atom includes a fluorine atom, chlorine atom and bromine atom.

The aliphatic group includes an alkyl group, substituted alkyl group, alkenyl group, substituted alkenyl group, alkynyl group, substituted alkynyl group, aralkyl group and substituted aralkyl group. The aliphatic group may be branched or it may form a ring. The number of carbon atoms in the aliphatic group is preferably 1 to 20, and more preferably 1 to 16. The aryl moiety of the aralkyl group and substituted aralkyl group is preferably phenyl or naphthyl, and more preferably phenyl. Examples of the aliphatic group include a methyl group, ethyl group, butyl group, isopropyl group, t-butyl group, hydroxyethyl group, methoxyethyl group, cyanoethyl group, trifluoromethyl group, 3-sulfopropyl group, 4-sulfobutyl group, cyclohexyl group, benzyl group, 2-phenethyl group, vinyl group and allyl group.

As used herein, the aromatic group refers to an aryl group and a substituted aryl group. The aryl group is preferably a phenyl or naphthyl group, and more preferably a phenyl group. The number of carbon atoms in the aromatic group is preferably 6 to 20, and more preferably 6 to 16.

Preferable examples of the aromatic group include a phenyl group, p-tolyl group, p-methoxyphenyl group, o-chlorophenyl group and m-(3-sulfopropylamino)phenyl group.

The heterocyclic group includes a heterocyclic group having a substituent and an unsubstituted heterocyclic group. An aliphatic group, aromatic ring or another heterocyclic ring may be condensed with the heterocyclic ring. The heterocyclic group is preferably a 5- or 6-membered heterocyclic group. Examples of the substituent include an aliphatic group, halogen atom, alkylsulfonyl group, arylsulfonyl group, acyl group, acylamino group, sulfamoyl group, carbamoyl group and ionic hydrophilic group. Examples of the heterocyclic group include a 2-pyridyl group, 2-thienyl group, 2-thiazolyl group, 2-benzothiazolyl group, 2-benzoxazolyl group and 2-furyl group.

Examples of the alkylsulfonyl group and arylsulfonyl group include a methanesulfonyl group and phenylsulfonyl group, respectively.

Examples of the alkylsulfinyl group and arylsulfinyl group include a methanesulfinyl group and phenylsulfinyl group, respectively.

The acyl group includes an acyl group having a substituent and an unsubstituted acryl group. The acyl group is preferably a C₁₋₁₂ acyl group. Examples of the substituent include an ionic hydrophilic group. Examples of the acyl group include an acetyl group and benzoyl group.

The amino group includes an amino group substituted with an alkyl, aryl and heterocyclic group, and the alkyl, aryl and heterocyclic group may further have a substituent. The amino group does not include an unsubstituted amino group. The alkylamino group is preferably a C₁₋₆ alkylamino group. Examples of the substituent include an ionic hydrophilic group. Examples of the alkylamino group include a methylamino group and diethylamino group.

The arylamino group includes an arylamino group having a substituent and an unsubstituted arylamino group. The arylamino group is preferably a C₆₋₁₂ arylamino group. Examples of the substituent include a halogen atom and ionic hydrophilic group. Examples of the arylamino group include an anilino group and 2-chloroanilino group.

The alkoxy group includes an alkoxy group having a substituent group and an unsubstituted alkoxy group. The alkoxy group is preferably a C₁₋₁₂ alkoxy group. Examples of the substituent include an alkoxy group, hydroxyl group and ionic hydrophilic group. Examples of the alkoxy group include a methoxy group, ethoxy group, isopropoxy group, methoxyethoxy group, hydroxyethoxy group and 3-carboxypropoxy group.

The aryloxy group includes an aryloxy group having a substituent and an unsubstituted aryloxy group. The aryloxy group is preferably a C₆₋₁₂ aryloxy group. Examples of the substituent include an alkoxy group and ionic hydrophilic group. Examples of the aryloxy group include a phenoxy group, p-methoxyphenoxy group and o-methoxyphenoxy group.

The acylamino group includes an acylamino group having a substituent. The acylamino group is preferably a C₂₋₁₂ acylamino group. Examples of the substituent include an ionic hydrophilic group. Examples of the acylamino group include an acetylamino group, propionylamino group, benzoylamino group, N-phenylacetylamino and 3,5-disulfobenzoylamino group.

The ureido group includes an ureido group having a substituent and an unsubstituted ureido group. The ureido group is preferably a C₁₋₁₂ ureido group. Examples of the substituent include an alkyl group and aryl group. Examples of the ureido group include a 3-methylureido group, 3,3-dimethylureido group and 3-phenylureido group.

The sulfamoylamino group includes a sulfamoylamino group having a substituent and an unsubstituted sulfamoylamino group. Examples of the substituent include an alkyl group. Examples of the sulfamoylamino group include an N,N-dipropylsulfamoylamino group.

The alkoxycarbonylamino group includes an alkoxycarbonylamino group having a substituent and an unsubstituted alkoxycarbonylamino group. The alkoxycarbonylamino group is preferably a C₂₋₁₂ alkoxycarbonylamino group. Examples of the substituent include an ionic hydrophilic group. Examples of the alkoxycarbonylamino group include an ethoxycarbonylamino group.

The alkylsulfonylamino group and arylsulfonylamino group include alkyl and arylsulfonylamino groups having a substituent and unsubstituted alkyl and arylsulfonylamino groups. The alkyl and arylsulfonylamino groups are preferably C₁₋₁₂ alkyl and arylsulfonylamino groups. Examples of the substituent include an ionic hydrophilic group. Examples of the alkyl and arylsulfonylamino groups include a methanesulfonylamino group, N-phenylmethanesulfonylamino group, benzenesulfonylamino group, and 3-carboxybenzenesulfonylamino group.

The carbamoyl group includes a carbamoyl group having a substituent and an unsubstituted carbamoyl group. Examples of the substituent include an alkyl group. Examples of the carbamoyl group include a methylcarbamoyl group and dimethylcarbamoyl group.

The sulfamoyl group includes a sulfamoyl group having a substituent and an unsubstituted sulfamoyl group. Examples of the substituent include an alkyl group. Examples of the sulfamoyl group include a dimethylsulfamoyl group and di-(2-hydroxyethyl)sulfamoyl group.

The alkoxycarbonyl group includes an alkoxycarbonyl group having a substituent and an unsubstituted alkoxycarbonyl group. The alkoxycarbonyl group is preferably a C₂₋₁₂ alkoxycarbonyl group. Examples of the substituent include an ionic hydrophilic group. Examples of the alkoxycarbonyl group include a methoxycarbonyl group and ethoxycarbonyl group.

The acyloxy group includes an acyloxy group having a substituent and an unsubstituted acyloxy group. The acyloxy group is preferably a C₁₋₁₂ acyloxy group. Examples of the substituent include an ionic hydrophilic group. Examples of the acyloxy group include an acetoxy group and benzoyloxy group.

The carbamoyloxy group includes a carbamoyloxy group having a substituent and an unsubstituted carbamoyloxy group. Examples of the substituent include an alkyl group. Examples of the carbamoyloxy group include an N-methylcarbamoyloxy group.

The aryloxycarbonyl group includes an aryloxycarbonyl group having a substituent and an unsubstituted aryloxycarbonyl group. The aryloxycarbonyl group is preferably a C₇₋₁₂ aryloxycarbonyl group. Examples of the substituent include an ionic hydrophilic group. Examples of the aryloxycarbonyl group include a phenoxycarbonyl group.

The aryloxycarbonylamino group includes an aryloxycarbonylamino group having a substituent and an unsubstituted aryloxycarbonylamino group. The aryloxycarbonylamino group is preferably a C₇₋₁₂ aryloxycarbonylamino group. Examples of the substituent include an ionic hydrophilic group. Examples of the aryloxycarbonylamino group include a phenoxycarbonylamino group.

The alkyl, aryl and heterocyclic thio groups include an alkyl, aryl and heterocyclic thio groups having a substituent and unsubstituted alkyl, aryl and heterocyclic thio groups. The alkyl, aryl and heterocyclic thio groups are preferably those each having 1 to 12 carbon atoms. Examples of the substituent include an ionic hydrophilic group. Examples of the alkyl, aryl and heterocyclic thio groups include a methylthio group, phenylthio group and 2-pyridylthio group.

The azo dye preferably for use in the invention is the compound represented by formula (M-II):

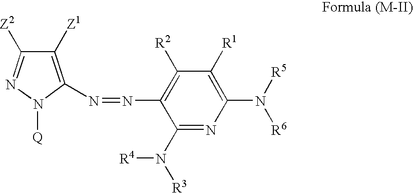

In formula (M-II), Z¹ represents an electron-withdrawing group having a Hammett's substituent constant σₚ value of 0.20 or more. Z¹ is preferably an electron-withdrawing group having the σₚ value of 0.30 to 1.0. Preferable examples of the substituent include electron-withdrawing substituents to be described later. In particular, Z¹ is preferably a C₂₋₁₂ acyl group, C₂₋₁₂ alkyloxycarbonyl group, nitro group, cyano group, C₁₋₁₂ alkylsulfonyl group, C₁₋₈ arylsulfonyl group, C₁₋₁₂ carbamoyl group or C₁₋₁₂ halogenated alkyl group, more preferably a cyano group, C₁₋₁₂ alkylsulfonyl group or C₆₋₁₈ arylsulfonyl group, and most preferably a cyano group.

R¹, R², R⁵ and R⁶ have the same meanings as defined in formula (M-I) above.

R³ and R⁴ each independently represent a hydrogen atom, aliphatic group, aromatic group, heterocyclic group, acyl group, alkoxycarbonyl group, aryloxycarbonyl group, carbamoyl group, alkylsulfonyl group, arylsulfonyl group or sulfamoyl group. R³ and R⁴ each are more preferably a hydrogen atom, aromatic group, heterocyclic group, acyl group, alkylsulfonyl group or arylsulfonyl group, with a hydrogen atom, aromatic group or heterocyclic group being particularly preferable.

Z² represents a hydrogen atom, aliphatic group, aromatic group or heterocyclic group.

Q represents a hydrogen atom, aliphatic group, aromatic group or heterocyclic group. In particular, Q is preferably a group consisting of non-metal atoms necessary for forming a 5- to 8-membered ring. The 5- to 8-membered ring may have a substituent, may be a saturated ring or may have an unsaturated bond. In particular, the 5- to 8-membered ring is preferably an aromatic group or heterocyclic group. The non-metal atom is preferably a nitrogen atom, oxygen atom, sulfur atom or carbon atom. Preferable examples of the 5- to 8-membered ring include a benzene ring, cyclopentane ring, cyclohexane ring, cycloheptane ring, cyclooctane ring, cyclohexene ring, pyridine ring, pyrimidine ring, pyrazine ring, pyridazine ring, triazine ring, imidazole ring, benzimidazole ring, oxazole ring, benzoxazole ring, thiazole ring, benzothiazole ring, oxane ring, sulfolane ring and thiane ring.

The respective groups described in formula (M-II) above may further have a substituent. When these groups further have a substituent, examples thereof include the groups described in formula (M-I) above and the groups and ionic hydrophilic groups exemplified for G, R¹ and R² above.

In connection with the substituent Z¹, the Hammett's substituent constant σₚ value as used herein will be explained below.

The Hammett's rule is an empirical rule proposed by L. P. Hammett in 1935 to quantitatively discuss the influence of a substituent on the reaction or equilibrium of benzene derivatives, and at present this rule is generally recognized valid. The substituent constant of the Hammett's rule includes σₚ value and σₘ value, and these values are found in many books and detailed, for example, in Lange's Handbook of Chemistry, 12th Ed. (1979), edited by J. A. Dean McGraw-Hill, and Region of Chemistry (in Japanese), Extra Issue, No. 122, pp. 96-103 (1979), Nankodo. In the invention, the respective substituents are limited as described by the Hammett's constant σₚ, but this does not mean that the substituents are limited to those having known values found in the above books, but means that the substituent groups encompass those having Hammett's constant σₚ value which when measured according to the Hammett's rule, are within a range specified in the invention even if their values are not known. The compound represented by formulae (M-I) to (M-V) in the invention cover the compounds which are not benzene compounds, however, the σ_{g} value is used regardless of the substituent position as a criterion indicative of the electron effect of the substituent. As used herein, the σₚ value has such a meaning.

The electron-withdrawing group having a Hammett's substituent constant σₚ value of 0.60 or more includes a cyano group, nitro group, alkylsulfonyl group (e.g., a methanesulfonyl group), an arylsulfonyl group (e.g., a benzenesulfonyl group), etc.

The electron-withdrawing group having a Hammett's substituent constant σₚ value of 0.45 or more includes those described above, and additionally, an acyl group (e.g., an acetyl group), an alkoxycarbonyl group (e.g., a dodecyloxycarbonyl group), an aryloxycarbonyl group (e.g., an m-chlorophenoxycarbonyl group), an alkylsulfinyl group (e.g., an n-propylsulfinyl group), an arylsulfinyl group (e.g., a phenylsulfinyl group), a sulfamoyl group (e.g., an N-ethylsulfamoyl group, N,N-dimethylsulfamoyl group), a halogenated alkyl group (e.g., a trifluoromethyl group), etc.

The electron-withdrawing group having a Hammett's substituent constant vσₚ value of 0.30 or more includes those described above, and additionally, an acyloxy group (e.g., an acetoxy group), a carbamoyl group (e.g., an N-ethylcarbamoyl group, N,N-dibutylcarbamoyl group), a halogenated alkoxy group (e.g., a trifluoromethyloxy group), a halogenated aryloxy group (e.g., a pentafluorophenyloxy group), a sulfonyloxy group (e.g., a methylsulfonyloxy group), a halogenated alkylthio group (e.g., a difluoromethylthio group), an aryl group substituted with two or more electron-withdrawing groups each having a Hammett's substituent constant σₚ value of 0.15 or more (e.g., a 2,4-dinitrophenyl group, pentachlorophenyl group), and a heterocyclic ring (e.g., a 2-benzoxazolyl group, 2-benzothiazolyl group, and 1-phenyl-2-benzimidazolyl group).

The electron-withdrawing group having a Hammett's substituent constant σₚ value of 0.20 or more includes those described above and halogen atoms.

Preferable combinations of substituents on the compound represented by formula (M-I) are described below:

(A) R⁵ and R⁶ are each preferably a hydrogen atom, alkyl group, aryl group, heterocyclic group, sulfonyl group or acyl group, more preferably a hydrogen atom, aryl group, heterocyclic group or sulfonyl group, and most preferably a hydrogen atom, aryl group or heterocyclic group. However, R⁵ and R⁶ are not simultaneously hydrogen atoms.

(B) G is preferably a hydrogen atom, halogen atom, alkyl group, hydroxyl group, amino group or amide group, more preferably a hydrogen atom, halogen atom, amino group or amide group, and most preferably a hydrogen atom, amino group or amide group.

(C) A is preferably a pyrazole ring, imidazole ring, isothiazole ring, thiadiazole ring or benzothiazole ring, more preferably a pyrazole ring or isothiazole ring, and most preferably a pyrazole ring.

(D) Each of B¹ and B² is ═CR¹— or —CR²═, and each of R¹ and R² is preferably a hydrogen atom, halogen atom, cyano group, carbamoyl group, carboxyl group, alkyl group, hydroxyl group or alkoxy group, and more preferably a hydrogen atom, cyano group, carbamoyl group or alkoxy group.

The compounds represented by formula (M-I) are preferably those in which at least one of substituents, preferably two or more substituents, and more preferably all substituents are the substituents exemplified above.

Illustrative compounds (a-1 to a-27, b-1 to b-6, c-I to c-3, d-1 to d-4, e-1 to e-4) represented by formula (M-I) above are shown in paragraphs [0190] to [0198] in Japanese Patent Application No. 2002-10361, and the invention is not limited to the exemplary compounds shown below.

The oil-soluble dye used in the invention is preferably a compound represented by the following formula (C-I) (hereinafter sometimes referred to as “phthalocyanine dye”). Hereinafter, the compound represented by formula (C-I) is described.

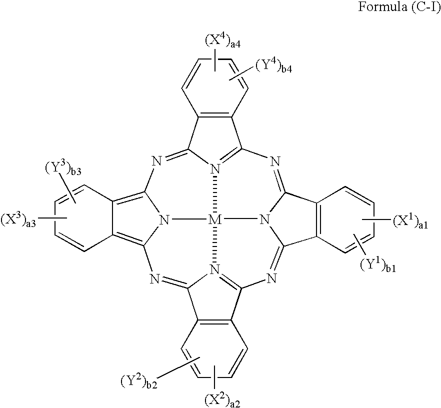

wherein X¹, X², X³ and X⁴ each independently represent —SO-Z¹, —SO₂-Z¹ or —SO₂NR²R²².

Z¹ represents a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group, and more preferably a substituted or unsubstituted alkyl group, a substituted or unsubstituted aryl group, or a substituted or unsubstituted heterocyclic group, with a substituted alkyl group, a substituted aryl group and a substituted heterocyclic group being most preferable.

R²¹ and R²² each independently represent a hydrogen atom, a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group, more preferably a hydrogen atom, a substituted or unsubstituted alkyl group, a substituted or unsubstituted aryl group, or a substituted or unsubstituted heterocyclic group, with a hydrogen atom, a substituted alkyl group, a substituted aryl group and a substituted heterocyclic group being most preferable. However, R²¹ and R²² are not simultaneously hydrogen atoms.

The substituted or unsubstituted alkyl group represented by R²¹, R²² and Z¹ is preferably a C₁₋₃₀ alkyl group. Examples of the substituent include substituent groups described later which can be possessed by Z¹, R²¹, R²², Y¹, Y², Y³ and Y⁴. Among these, a hydroxyl group, alkoxy group, cyano group and halogen atom are preferable.

The substituted or unsubstituted cycloalkyl group represented by R²¹, R²² and Z¹ is preferably a C₅₋₃₀ cycloalkyl group. Examples of the substituent include the substituents, as described later, which Z¹, R²¹, R²², Y¹, Y², Y³ and Y⁴ may have as additional substituents. Among these, a hydroxyl group, alkoxy group, cyano group and a halogen atom are preferable.

The substituted or unsubstituted alkenyl group represented by R²¹, R²² and Z¹ is preferably a C₂₋₃₀ alkenyl group. Examples of the substituent include the substituents, as described later, which Z¹, R²¹, R²², Y¹, Y², Y³ and Y⁴ may have as additional substituents. Among these, a hydroxyl group, alkoxy group, cyano group and a halogen atom are preferable.

The substituted or unsubstituted aralkyl group represented by R²¹, R²² and Z¹ is preferably a C₇₋₃₀ aralkyl group. Examples of the substituent include the substituents, as described later, which Z¹, R²¹, R²², Y¹, Y², Y³ and Y⁴ may have as additional substituents. Among these, a hydroxyl group, alkoxy group, cyano group and a halogen atom are preferable.

Substituents on the aryl group represented by R²¹, R²² and Z¹ include the substituents, as described later, which Z¹, R²¹, R²², Y¹, Y², Y³ and Y⁴ may have as additional substituents. The substituent is preferably a halogen atom, heterocyclic group, cyano group, hydroxyl group, nitro group, carboxyl group, acylamino group, ureido group, sulfamoylamino group, alkyloxycarbonyl group, alkyloxycarbonylamino group, sulfonamide group, sulfamoyl group, carbamoyl group, sulfonyl group, acyloxy group, carbamoyloxy group, imide group, heterocyclic thio group, acyl group, sulfo group or quaternary ammonium group, more preferably a heterocyclic group, cyano group, carboxyl group, acylamino group, sulfonamide group, sulfamoyl group, carbamoyl group, sulfonyl group, imide group or acyl group, still more preferably a cyano group, carboxyl group, sulfamoyl group, carbamoyl group, sulfonyl group, imide group or acyl group.

The heterocyclic group represented by R²¹, R²² and Z¹ is preferably a 5- or 6-membered ring which may be further condensed. The heterocyclic group may be an aromatic or a non-aromatic heterocyclic ring.

Hereinafter, the heterocyclic group represented by R²′, R²² and Z¹ is exemplified as a heterocyclic ring without mentioning the substittuent position. The positions of the substituent are not limited. For example, pyridine may be substituted at a 2-, 3- or 4-position.

Mention is made of pyridine, pyrazine, pyrimidine, pyridazine, triazine, quinoline, isoquinoline, quinazoline, cinnoline, phthalazine, quinoxaline, pyrrole, indole, furan, benzofuran, thiophene, benzothiophene, pyrazole, imidazole, benzimidazole, triazole, oxazole, benzoxazole, thiazole, benzothiazole, isothiazole, benzisothiazole, thiadiazole, isoxazole, benzisoxazole, pyrrolidine, piperidine, piperazine, imidazolidine, thiazoline, etc. Among those listed above, the aromatic heterocyclic group is preferable, and representative examples thereof include pyridine, pyrazine, pyrimidine, pyridazine, triazine, pyrazole, imidazole, benzimidazole, triazole, thiazole, benzothiazole, isothiazole, benzisothiazole and thiadiazole. These may have a substituent.

Y¹, Y², Y³ and Y⁴ each independently represent a hydrogen atom, halogen atom, alkyl group, cycloalkyl group, alkenyl group, aralkyl group, aryl group, heterocyclic group, cyano group, hydroxyl group, nitro group, amino group, alkylamino group, alkoxy group, aryloxy group, amide group, arylamino group, ureido group, sulfamoylamino group, alkylthiol group, arylthio group, alkoxcarbonylamino group, sulfonamide group, carbamoyl group, sulfamoyl group, sulfonyl group, alkoxycarbonyl group, heterocyclic oxy group, azo group, acyloxy group, carbamoyloxy group, silyloxy group, aryloxycarbonyl group, aryloxycarbonylamino group, imide group, heterocyclic thio group, phosphoryl group, acyl group, carboxyl group or sulfo group, and each of which may further have a substituent.

Y¹, Y², Y³ and Y⁴ each are more preferably a hydrogen atom, halogen atom, alkyl group, aryl group, cyano group, alkoxy group, amide group, ureido group, sulfonamide group, carbamoyl group, sulfamoyl group or alkoxycarbonyl group, still more preferably a hydrogen atom, halogen atom or cyano group, and most preferably a hydrogen atom.

When Z¹ R²¹, R²², Y¹, Y², Y³ or Y⁴ is a group which may have an additional substituent, it may further have substituents shown below.

Mention is made of a halogen atom (e.g., a chlorine atom, bromine atom), a C₁₋₃₀ linear or branched alkyl group, a C₇₋₃₀ aralkyl group, a C₂₋₃₀ alkenyl group, a C₂₋₃₀ linear or branched alkynyl group, a C₃₋₃₀ linear or branched cycloalkyl group, a C₃₋₃₀ linear or branched cycloalkenyl group (e.g., methyl, ethyl, propyl, isopropyl, t-butyl, 2-methanesulfonylethyl, 3-phenoxypropyl, trifluoromethyl and cyclopentyl), an aryl group (e.g., phenyl, 4-t-butylphenyl, 2,4-di-t-amylphenyl), a heterocyclic group (e.g., imidazolyl, pyrazolyl, triazolyl, 2-furyl, 2-thienyl, 2-pyrimidinyl, 2-benzothiazolyl), a cyano group, hydroxyl group, nitro group, carboxy group, amino group, alkyloxy group (e.g., methoxy, ethoxy, 2-methoxyethoxy, 2-methanesulfonylethoxy), an aryloxy group (e.g., phenoxy, 2-methylphenoxy, 4-t-butylphenoxy, 3-nitrophenoxy, 3-t-butyloxycarbamoylphenoxy, 3-methoxycarbamoyl), an acylamino group (e.g., acetamide, benzamide, 4-(3-t-butyl-4-hydroxyphenoxy)butanamide), an alkylamino group (e.g., methylamino, butylamino, diethylamino, methylbutylamino), an anilino group (e.g., phenylamino, 2-chloroanilino), an ureido group (e.g., phenylureido, methylureido, N,N-dibutylureido), a sulfamoylamino group (e.g., N,N-dipropylsulfamoylamino), an alkythio group (e.g., methylthio, octylthio, 2-phenoxyethylthio), an arylthio group (e.g., phenylthio, 2-butoxy-5-t-octylphenylthio, 2-carboxyphenylthio), an alkyloxycarbonylamino group (e.g., methoxycarbonylamino), a sulfonamide group (e.g., methanesulfonamide, benzenesulfonamide, p-toluenesulfonamide), a carbamoyl group (e.g., N-ethylcarbamoyl, N,N-dibutylcarbamoyl), a sulfamoyl group (e.g., N-ethylsulfamoyl, N,N-dipropylsulfamoyl, N-phenylsulfamoyl), a sulfonyl group (e.g., methanesulfonyl, octanesulfonyl, benzenesulfonyl, toluenesulfonyl), an alkyloxycarbonyl group (e.g., methoxycarbonyl, butyloxycarbonyl), a heterocyclic oxy group (e.g., 1-phenyltetrazol-5-oxy, 2-tetrahydropyranyloxy), an azo group (e.g., phenylazo, 4-methoxyphenylazo, 4-pivaloylaminophenylazo, 2-hydroxy-4-propanoylphenylazo), an acyloxy group (e.g., acetoxy), a carbamoyloxy group (e.g., N-methylcarbamoyloxy, N-phenylcarbamoyloxy), a silyloxy group (e.g., trimethylsilyloxy, dibutylmethylsilyloxy), an aryloxycarbonylamino group (e.g., phenoxycarbonylamino), an imide group (e.g., N-succinimide, N-phthalimide), a heterocyclic thio group (e.g., 2-benzothiazolylthio, 2,4-di-phenoxy-1,3,5-triazole-6-thio, 2-pyridylthio), a sulfinyl group (e.g., 3-phenoxypropylsulfinyl), a phosphonyl group (e.g., phenoxyphosphonyl, octyloxyphosphonyl, phenylphosphonyl), an aryloxycarbonyl group (e.g., phenoxycarbonyl), an acyl group (e.g., acetyl, 3-phenylpropanoyl, benzoyl), an ionic hydrophilic group (e.g., a carboxyl group, sulfo group and quaternary ammonium group), etc.

a¹ to a⁴ and b¹ to b⁴, respectively, represent the number of the substituents X¹ to X⁴ and Y¹ to Y⁴, a¹ to a⁴ each independently represent an integer of 0 to 4, and b¹ to b⁴ each independently represent an integer of 0 to 4, respectively. However, the sum of a¹ to a⁴ is 2 or greater. When a¹ to a⁴ and b¹ to b⁴ each represent an integer of 2 or greater, the respective X¹ to X⁴ and Y¹ to Y⁴ may be the same or different.

a¹ and b¹ each independently represent an integer of 0 to 4 satisfying an equation of a¹+b¹=4, wherein a particularly preferable combination is that a¹ is 1 or 2 and b¹ is 3 or 2, and the most preferable combination is that a¹ is 1 and b¹ is 3.

a² and b² each independently represent an integer of 0 to 4 satisfying an equation of a²+b²=4, wherein a particularly preferable combination is that a² is 1 or 2 and b² is 3 or 2, and the most preferable combination is that a² is 1 and b² is 3.

a³ and b³ each independently represent an integer of 0 to 4 satisfying an equation of a³+b³=4, wherein a particularly preferable combination is that a³ is 1 or 2 and b³ is 3 or 2, and the most preferable combination is that a³ is 1 and b³ is 3.

a⁴ and b⁴ each independently represent an integer of 0 to 4 satisfying an equation of a⁴+b⁴=4, wherein a particularly preferable combination is that a⁴ is 1 or 2 and b⁴ is 3 or 2, and the most preferable combination is that a¹ is 1 and b⁴ is 3.

M represents a hydrogen atom or a metal element, and the oxide, hydroxide or halide thereof.

Preferable examples of M include a hydrogen atom and metal atoms such as Li, Na, K, Mg, Ti, Zr, V, Nb, Ta, Cr, Mo, W, Mn, Fe, Co, Ni, Ru, Rh, Pd, Os, Ir, Pt, Cu, Ag, Au, Zn, Cd, Hg, Al, Ga, In, Si, Ge, Sn, Pb, Sb and Bi. The oxide includes VO, GeO, etc. The hydroxide includes Si(OH)₂, Cr(OH)₂, Sn(OH)₂, etc. The halide includes AlCl, SiCl₂, VCl, VCl₂, VOCl, FeCl, GaCl, ZrCl, etc. Among these, Cu, Ni, Zn and Al are preferable, and Cu is most preferable.

Further, Pc (phthalocyanine ring) may form a dimer (e.g., Pc-M-L-M-Pc) or a trimer via L (divalent linking group), wherein M may be the same or different.

The divalent linking group represented by L is preferably an oxy group (—O—), thio group (—S—), carbonyl group (—CO—), sulfonyl group (—SO₂—), imino group (—NH—) or methylene group (—CH₂—).

A particularly preferable combination in the compound represented by formula (C-I) is as follows:

X¹ to X⁴ each independently are particularly preferably —SO₂-Z¹ or —SO₂NR²¹R²².

Z¹ is preferably a substituted or unsubstituted alkyl group, a substituted or unsubstituted aryl group or a substituted or unsubstituted heterocyclic group, and most preferably a substituted alkyl group, a substituted aryl group or a substituted heterocyclic group.

R²¹ and R²² each independently are preferably a hydrogen atom, a substituted or unsubstituted alkyl group, a substituted or unsubstituted aryl group or a substituted or unsubstituted heterocyclic group, most preferably a hydrogen atom, a substituted alkyl group, a substituted aryl group or a substituted heterocyclic group.

Y¹ to Y⁴ each are peferably a hydrogen atom, halogen atom, alkyl group, aryl group, cyano group, alkoxy group, amide group, ureido group, sulfonamide group, carbamoyl group, sulfamoyl group, alkoxycarbonyl group, carboxyl group or sulfo group, and more preferably a hydrogen atom, halogen atom, cyano group, carboxyl group or sulfo group, with a hydrogen atom being most preferable.

a¹ to a⁴ each independently are preferably 1 or 2, and particularly preferably 1. b¹ to b⁴ each independently are preferably 3 or 2, and particularly preferably 3.

M is a hydrogen atom or a metal element, and the oxide, hydroxide or halide thereof, more preferably Cu, Ni, Zn or Al, and most preferably Cu.

The compound represented by formula (C-I) is preferably a compound wherein at least one substituent, preferably two or more substituents, more preferably all substituents are the preferable groups described above.

The compound represented by formula (C-I) is most preferably a compound represented by formula (C-II):

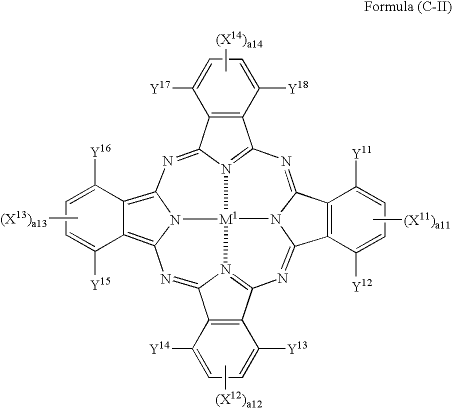

wherein X¹¹ to X¹⁴ and Y¹¹ to Y¹⁸ have the same meanings as those of X¹ to X⁴ and Y¹ to Y⁴ defined in formula (C-I) above, respectively, and preferable examples of these groups are also the same as defined above. M¹ has the same meaning as that of M defined in formula (C-I), and preferable examples thereof are also the same as defined above.

Specifically, X¹¹, X¹², X¹³ and X¹⁴ in formula (C-II) each independently represent —SO-Z¹¹, —SO₂-Z¹¹ or —SO₂NR²³R²⁴.

Z¹¹ represents a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group.

R²³ represents a hydrogen atom, a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group; and R²⁴ represents a substituted or unsubstituted alkyl group, a substituted or unsubstituted cycloalkyl group, a substituted or unsubstituted alkenyl group, a substituted or unsubstituted aralkyl group, a substituted or unsubstituted aryl group, or a substituted or unsubstituted heterocyclic group.

Y¹¹, Y¹², Y¹³, Y¹⁴, Y¹⁵, Y¹⁶, Y¹⁷ and Y¹⁸ each independently represent a hydrogen atom, halogen atom, alkyl group, cycloalkyl group, alkenyl group, aralkyl group, aryl group, heterocyclic group, cyano group, hydroxyl group, nitro group, amino group, alkylamino group, alkoxy group, aryloxy group, amide group, arylamino group, ureido group, sulfamoylamino group, alkylthiol group, arylthio group, alkoxycarbonylamino group, sulfonamide group, carbamoyl group, alkoxycarbonyl group, heterocyclic oxy group, azo group, acyloxy group, carbamoyloxy group, silyloxy group, aryloxycarbonyl group, aryloxycarbonylamino group, imide group, heterocyclic thio group, phosphoryl group, acyl group, carboxyl group or sulfo group, each of which may further have a substituent.

a¹¹ to a¹⁴ each represent the number of the substituent X¹¹ to X¹⁴, respectively, and each represent an integer of 0 to 2, provided that all to a¹⁴ are not simultaneously 0. When a¹¹ to a¹⁴ each represent 2, two of the substituents X¹¹ to X¹⁴ may be the same or different.

M¹ represents a hydrogen atom or a metal element, and the oxide thereof, the hydroxide thereof or the halide thereof.

In formula (C—II), a¹¹ to a¹⁴ each independently represent an integer of 1 or 2 satisfying an equation of 4≦a¹¹+a¹²+a¹³+a¹⁴≦8, more preferably 4≦a¹¹+a¹²+a¹³+a¹⁴≦6, and still more preferably a¹¹=a¹²=a¹³=a¹⁴=1.

Preferable combinations of substituents in the compound represented by formula (C-II) are described below:

X¹¹ to X¹⁴ each independently are particularly preferably —SO₂-Z¹¹ or —SO₂NR²³R²⁴.

Z¹¹ is preferably a substituted or unsubstituted alkyl group, a substituted or unsubstituted aryl group or a substituted or unsubstituted heterocyclic group, and more preferably a substituted alkyl group, a substituted aryl group or a substituted heterocyclic group.

R²³ is preferably a hydrogen atom, a substituted or unsubstituted alkyl group, a substituted or unsubstituted aryl group or a substituted or unsubstituted heterocyclic group, and more preferably a hydrogen atom, a substituted alkyl group, a substituted aryl group or a substituted heterocyclic group.

R²⁴ is preferably a substituted or unsubstituted alkyl group, a substituted or unsubstituted aryl group or a substituted or unsubstituted heterocyclic group, and more preferably a substituted alkyl group, a substituted aryl group or a substituted heterocyclic group.

Y¹¹ to Y¹⁸ each independently are preferably a hydrogen atom, halogen atom, alkyl group, aryl group, cyano group, alkoxy group, amide group, ureido group, sulfonamide group, carbamoyl group, sulfamoyl group or alkoxycarbonyl group, more preferably a hydrogen atom, halogen atom or cyano group, and most preferably a hydrogen atom.

a¹¹ to a¹⁴ each independently are preferably 1 or 2, and it is particularly preferable that all of a¹¹ to a¹⁴ are 1.

M¹ represents a hydrogen atom or a metal element, and the oxide, hydroxide or halide thereof, more preferably Cu, Ni, Zn and Al, and most preferably Cu.

The compound represented by formula (C-II) is preferably a compound wherein at least one substituent, preferably two or more substituents, and more preferably all substituents are the preferable groups described above.

It is ordinary that the compound represented by formula (C-I) is generally a mixture of analogues which are inevitably different in the position of the substitiuents Rn (n=1 to 4) and Yq (q=1 to 4) and the number of the substituents depending on its synthesis method, and the mixture of these analogues is usually expressed as a statistically averaged mixture. In the invention, when the mixtures of these analogues are divided into the following 3 mixtures, a specific mixture was found to be particularly preferable.

In the present invention, the mixtures of phthalocyanine dye analogues, that is, the compounds represented by formulae (C-I) and (C-II), are defined by dividing them into the following 3 mixtures depending on the positions of substituents.

(1) β-position substituted type: the phthalocyanine dye having a specific substituent at the 2- and/or 3-positions, 6- and/or 7-positions, 10- and/or 11-positions, and 14- and/or 15-positions.

(2) α-position substituted type: the phthalocyanine dye having a specific substituent at the 1- and/or 4-positions, 5- and/or 8-positions, 9- and/or 12-positions, and 13- and/or 16-positions.

(3) α- and β-positions substituted type: the phthalocyanine dye having a specific substituent randomly at the 1- to 16-positions.

As used herein, the phthalocyanine dye derivatives different in the structure (particularly with respect to the position of the substituent) are described by referring to the β-position substituted type, the α-position substituted type and the α- and β-positions substituted type compounds.

The phthalocyanine derivatives used in the invention can be synthesized by a combination of or referring to the methods described in “Phthalocyanines—Chemistry and Functions”—(pp. 1-62) written by Shirai & Kobayashi and published by I.P.C and in “Phthalocyanines—Properties and Applications”—(pp. 1-54) witten by C. C. Leznoff & A. B. P. Lever and published by VCH, or employing the similar methods.

The compounds represented by formula (C-I) for use in the invention can be synthesized thorough sulfonation, sulfonyl chloridation or amidation reaction of unsubstituted phthalocyanine compounds according to the methods described, for example, in WO 00/17275, WO 00/08103, WO 00/08101, WO 98/41853 and JP-A No. 10-36471. In this case, sulfonation may take place in any positions of the phthalocyanine nucleus, and the number of sulfonidation to occur is difficult to control. Consequently, when sulfo groups are introduced under such reaction conditions, the positions and number of sulfo groups introduced into the product cannot be specified, thus inevitably giving a mixture of compounds different in the number and positions of the substituent. Accordingly, when such a mixture is used as the starting material to synthesize the compound of the invention, the number and positions of the sulfamoyl substituent on the heterocyclic ring cannot be specified, and thus the compound of the invention is obtained as a mixture of compounds substituted at the α- and β-positions, containing several kinds of compounds different in the number and positions of the substituent.

As described above, when a larger number of electron-withdrawing groups such as a sulfamoyl group are introduced into the phthalocyanine nucleus, oxidation potential becomes higher, and ozone resistance is enchanced. When the above synthesis method is employed, the number of electron-withdrawing groups introduced is low, and hence, contamination with phthalocyanine dyes lower in oxidation potential is inevitable. Accordingly, synthesis methods capable of suppressing formation of compounds poorer in oxidation potential are employed more preferably in order to improve ozone resistance.

On the other hand, the compounds represented by formula (C-II) for use in the invention may be derived from the compounds obtained by reacting, for example, a phthalonitrile derivative (compound P) represented by the following formula and/or a diiminoisoindoline derivative (compound Q) represented by the following formula with a metal derivative represented by formula (C-III) shown below.

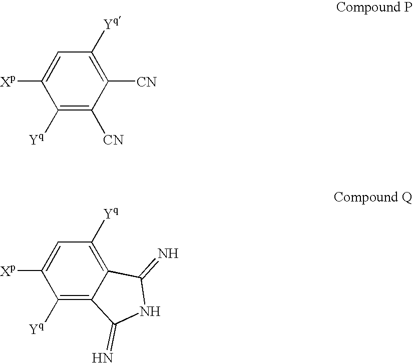

In the compounds P and Q, p represents 11 to 14, and q and q′ each independently represent 11 to 18.

M-(Y)_{d} Formula (C-III)

In the above formula (C-III), M has the same meaning as that of M in the compounds represented by formulae (C-I) and (C-II), Y represents a monovalent or divalent ligand such as a halogen atom, acetate anion, acetyl acetonate or oxygen, and d is an integer of 1 to 4.

Thus, if the synthesis method described above is employed, a specified number of desired substituents may be introduced. In particular, when it is desired to introduce a large number of electron-withdrawing groups for increasing oxidation potential as conducted in the invention, the above synthesis method is superior to the method of synthesizing the compounds represented by formula (C-I).

The thus obtained compounds represented by formula (C-II) are usually a mixture of compounds represented by formulae (C-II-1) to (C-II-4) shown below, which are the isomers with respect to the positions of XP groups, that is, the β-position substituted type compounds (phthalocyanine dyes having specific substituents at the 2- and/or 3-positions, the 6- and/or 7-positions, the 10- and/or 11-positions, the 14- and/or 15-positions).

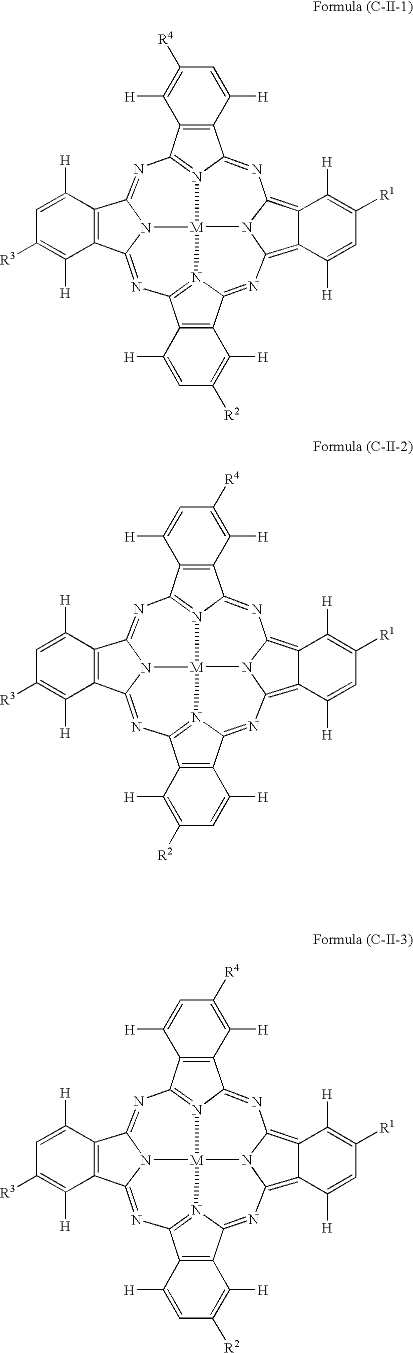

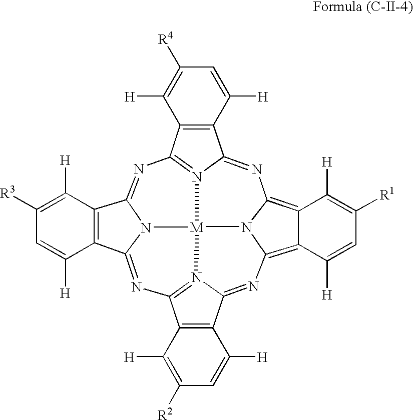

R¹ to R⁴ in formulae (C-II-1) to (C-II-4) have the same meanings as those of (X¹¹)a¹¹ to (X¹⁴)a¹⁴ in formula (C-II).

In the invention, oxidation potential higher than 1.0 V (vs SCE) is found to be critical to improve fastness in any substitution type compounds. In particular, the isomers substituted at the β-position are found to be superior to the isomers substituted at the α- and β-positions with respect to hue, light-fastness, ozone gas resistance, etc.

The exemplary compounds (C-101 to C-120) represented by formula (C-I) or (C-II) are shown in paragraphs [0264] to [0267] in Japanese Patent Application No. 2002-10361, but the invention is not limited to the exemplary compounds.

The compounds represented by formula (C-I) may be synthesized according to the above-mentioned patent. The compounds represented by formula (C-II) may be synthesized by the methods described in Japanese Patent Application Nos. 2000-24352, 2000-47013, 2000-57063 and 2000-96610. However, the starting materials, dye intermediates and a synthesizing route are not limited thereto.

The content of the oil-soluble dye for use in the ink composition of the invention is preferably 0.05 to 50% by mass, and more preferably 0.1 to 10% by mass, realtive to the ink composition.

(Colored Fine Particle Dispersion)

The colored fine particle dispersion of the invention comprises an oil-soluble dye alone or colored fine particles that contain the oil-soluble dye and the oil-soluble polymer, dispersed in an aqueous medium. The colored fine particle dispersion may further contain a hydrophobic high-boiling boiling point organic solvent having a boiling point of 150° C. or higher, or a colorant to develop colors other than magenta color or to regulate tone of color.

More specifically, the colored fine particle dispersion is in the form of an emulsified dispersion of the oil-soluble dye alone or the oil-soluble dye and the oil-soluble polymer, and if necessary a hydrophobic high-boiling point organic solvent and another colorant, dispersed as finely pulverized oil droplets in an aqueous medium.

The “aqueous medium” as used herein refers to water or a mixture of water and a small amount of water-miscible organic solvent, to which additives are optionally added.

<Oil-Soluble Polymer>

The oil-soluble polymer will now be described in more detail hereinafter. The oil-soluble polymer is not particularly limited, and conventionally known ones may be suitably selected and used depending on the purposes. Examples thereof include vinyl polymers and condensed polymers (polyurethane, polyester, polyamide, polyurea, and polycarbonate).

The oil-soluble polymer may be any of water-insoluble, water-dispersible (self-emulsifiable) or water-soluble polymer, among which the water-dispersible polymer is preferable in view of easy production and dispersion stability of the colored fine particles.

The water-dispersible polymer may be any of an ionic dissociative polymer, a nonionic dispersible group-containing polymer, or the combination thereof.

The ionic dissociative polymer includes a polymer having a cationic dissociative group such as tertiary amino group and a polymer having an anionic dissociative group of carboxylic acid or sulfonic acid.

The aforementioned nonionic dispersible group-containing polymer includes a polymer containing a nonionic dispersible group such as polyethyleneoxy group.

Among these polymers, the ionic dissociative polymer containing an anionic dissociative group, the polymer containing a nonionic dispersible group or the combination thereof is preferable from the standpoint of dispersion stability of the colored fine particles.

Preferable examples of the vinyl polymer and monomers to constitute the vinyl polymer are described in JP-A Nos. 2001-181547 and 2001-181549. Other examples of the monomers include cyano group-containing vinyl monomers (e.g., acrylonitrile, methacrylonitrile) and monomers which have a carboxyl group and monomers which, upon formation of a polymer, do not directly bind to a main chain of the polymer (e.g., carboxyethyl acrylate, 4-vinylbenzoic acid, 2-(2-acryloyloxyethyloxycarbonyl)propanoic acid, etc.).

Further, the polymers having a dissociative group introduced into the terminal of their polymer chain, by radical polymerization using a chain transferring agent or a polymerization initiator having a dissociable group (or a substituent group capable of conversion into a dissociative group) or by ionic polymerization using a compound having a dissociative group (or a substituent group capable of conversion into a dissociative group) as the initiator or terminator are preferable.

Preferable examples of the condensed polymer and monomers to constitute the condensed polymer are described in JP-A No. 2001-226613.

Regarding the oil-soluble polymer, each of starting materials may be used, or two or more kinds of the starting materials may be used in an arbitrary ratio depending on the purposes (e.g., regulation of the glass transition temperature (Tg) of the polymer, solubility of the polymer, affinity for a colorant, compatibility with a colorant, and stability of the dispersion).

In particular, the oil-soluble polymer having a dissociative group is preferable, with the oil-soluble polymer having a carboxyl group and/or a sulfonate group as the dissociative group being more preferable, and the oil-soluble polymer having a carboxyl group as the dissociative group being most preferable.

After undergoing polymerization, a dissociative group may be introduced into a reactive group such as hydroxy group or amino group of the polymer by effecting a reaction using a compound such as an acid anhydride (e.g., maleic anhydride).

The inclusion amount of the dissociative group is preferably 0.1 to 3.0 mmol/g, and more preferably 0.2 to 2.0 mm/g. If the amount of the dissociative group is small, the polymer is poor in self-emulsifiablity, while if it is large, the polymer is highly water-soluble and may sometimes become unsuitable to disperse the colorant.

Regarding dissociative groups, the anionic dissociative group may have the form of a salt with an alkali metal (e.g., Na, K) or a salt with an ammonium ion, and the cationic dissociative group may have the form of a salt with an organic acid (e.g., acetic acid, propionic acid, methanesulfonic acid) or an inorganic acid (e.g., hydrochloric acid, sulfuric acid).

The molecular weight (Mw) of the oil-soluble polymer is usually 1,000 to 200,000, and more preferably 2,000 to 50,000. If the molecular weight is less than 1,000, a stable dispersion of colored fine particles is hardly obtained. If the molecular weight is higher than 200,000, the polymer is poor in solubility in an organic solvent, and viscosity of the solution in an organic solvent is increased whereby dispersing operation becomes difficult.

In consideration of readily introduction of the dissociable group so as to confer affinity for a colorant, compatibility with a colorant and excellent dispersion stability, a particularly preferable oil-soluble polymer is particularly preferably a vinyl polymer, polyurethane and polyester.

Examples of the vinyl polymer include P-1) to P-105) described in JP-A No. 2001-181549, and additionally, PA-1) to PA-11) shown below. The ratio in the brackets refers to a ratio by weight. Specific examples of the condensed polymer include P-1) to P-38) described in JP-A No. 2001-226613.

However, the present invention is not limited to these examples.

PA-1) 2-Carboxyethyl acrylate/n-butyl methacrylate copolymer (10:90)

PA-2) 2-Carboxyethyl acrylate/diphenyl acrylamide/iso-butyl methacrylate copolymer (15:10:75)

PA-3) 2-Carboxyethyl acrylate/n-butyl methacrylate/diphenyl-2-methacryloyloxyethyl phosphate copolymer (10:60:30)

PA-4) N-(3-Carboxypropyl) acrylamide/tert-butyl methacrylamide/butyl acrylate copolymer (12:18:70)

PA-5) Poly n-butyl methacrylate obtained using mercaptoacetic acid as a chain transfer agent (3.4:96.6)

PA-6) Isobutyl methacrylate/butyl acrylate copolymer obtained using 2-mercaptosuccinic acid as a chain transfer agent (40:56:4)

PA-7) Acrylonitrile/methacrylonitrile/isopropyl methacrylate/2-carboxyethyl acrylate copolymer (40:40:15:5)

PA-8) Butyl acrylate/n-butyl methacrylate copolymer (20:80)

PA-9) N-t-butyl acrylamide/n-butyl methacrylate copolymer (50:50)

PA-10) N-t-butyl acrylamide/n-butyl acrylate/acrylic acid copolymer (30:67:3)

PA-11) Mono(acryloyloxyethyl)succinate/n-butyl methacrylate copolymer (15:85)

-Production of Dispersion of Colored Fine Particles-

The dispersion of colored fine particles of the invention is produced by dispersing the oil-soluble dye alone, or the oil-soluble dye together with the oil-soluble polymer, in the form of colored fine particles, in an aqueous medium (liquid containing at least water). Examples of the latter case include a method of preparing a latex of the oil-soluble polymer and then impregnating it with the oil-soluble dye, or a co-emulsifying dispersing method.

Among the methods, the co-emulsifying dispersing method is preferable. The co-emulsifying dispersing method is preferably conducted through emulsifying an organic solvent that contains the oil-soluble polymer and the oil-soluble dye to form fine particles, by adding the organic solvent to water or by adding water to the organic solvent.

The latex refers to a dispersion in which the oil-soluble polymer insoluble in an aqueous medium is dispersed as fine particles in an aqueous medium. The oil-soluble polymer may be any state in the dispersion, such as a state emulsified in the aqueous medium, an emulsion-polymerized state or a micell-dispersed state, or alternatively a molecule chain dispersed state in which the oil-soluble polymer having a partially hydrophilic structure in its molecule is in the aqueous medium.

First, the method of forming the polymer latex and then impregnating it with the oil-soluble dye is described.

A first example of this method comprises a first step of preparing the polymer latex, a second step of preparing an oil-soluble dye-containing solution having the oil-soluble dye dispersed or dissolved in an organic solvent, and a third step of mixing the oil-soluble dye-containing solution with the polymer latex to prepare a colored fine particle dispersion.

A second example of this method comprises a first step of preparing the polymer latex, a second step of preparing an oil-soluble dye-containing solution having the oil-soluble dye dispersed or dissolved in an organic solvent and then mixing the oil-soluble dye-containing solution with a liquid containing at least water to prepare a colored fine particle dispersion, and a third step of mixing the polymer latex with the colored fine particle dispersion, to prepare a colored fine particle dispersion.

A third example of this method includes a method described in JP-A No. 55-139471.

Next, the co-emulsifying dispersing method is described.

A first example of this method comprises a first step of preparing a polymer/dye mixture having the oil-soluble dye and the oil-soluble polymer dispersed or dissolved in an organic solvent and a second step of mixing the polymer/dye mixture with the liquid containing at least water to form a colored fine particle dispersion.

A second example of this method comprises a first step of preparing an oil-soluble dye-containing solution having the oil-soluble dye dispersed or dissolved in an organic solvent, a second step of preparing a polymer solution having the oil-soluble polymer dispersed or dissolved in an organic solvent, and a third step of mixing the oil-soluble dye-containing solution, the polymer solution, and the liquid containing at least water, to prepare a colored fine particle dispersion.

A third example of this method comprises a first step of preparing an oil-soluble dye-containing solution having the oil-soluble dye dispersed or dissolved in an organic solvent and mixing the oil-soluble dye-containing solution with a liquid containing at least water to prepare a fine oil-soluble dye particle dispersion, a second step of preparing a polymer solution having the oil-soluble polymer dispersed or dissolved in an organic solvent and then mixing the polymer solution with the liquid containing at least water to prepare a fine polymer particle dispersion, and a third step of mixing the fine oil-soluble dye particle dispersion with the fine polymer particle dispersion to prepare a colored fine particle dispersion.

A fourth example of this method comprises a first step of preparing an oil-soluble dye-containing solution having the oil-soluble dye dispersed or dissolved in an organic solvent and then mixing the oil-soluble dye-containing solution with a liquid containing at least water to prepare a fine oil-soluble dye particle dispersion, a second step of preparing a polymer solution having the oil-soluble polymer dispersed or dissolved in an organic solvent, and a third step of mixing the fine oil-soluble dye particle dispersion with the polymer solution to prepare a colored fine particle dispersion.

A fifth example of this method comprises a step of mixing a liqiud containing at least water with the oil-soluble dye and the oil-soluble polymer, to directly prepare a colored fine particle dispersion.

In the colored fine particle dispersion, the use amount of the oil-soluble polymer is preferably 10 to 1,000 parts by mass, more preferably 50 to 600 parts by mass, relative to 100 parts by mass of the oil-soluble dye. If the amount of the polymer used is less than 10 parts by mass, a fine and stable dispersion is hardly obtained. If the amount is higher than 1,000 parts by mass, the proportion of the oil-soluble dye in the colored fine particle dispersion is decreased, and when such a colored fine particle dispersion is used as aqueous ink, an ink formulation may become impossible.

The content of the colored fine particles in the colored fine particle dispersion is preferably 1 to 45% by mass, and more preferably 2 to 30% by mass. The content can appropriately be controlled by dilution, evaporation, ultrafiltration, etc.

The average particle diameter of the colored fine particles is preferably 1 to 500 nm, more preferably 3 to 300 nm, and still more preferably 3 to 200 nm. The particle diameter distribution is not particularly limited, and the colored fine particles may have a broad particle diameter distribution or a monodispersed particle diameter distribution. The particle diameter and the particle diameter distribution may be controlled by techniques such as centrifugation or filtration.

-Organic Solvent-

The organic solvents used for producing the colored fine particle dispersion are not particularly limited, and can suitably be selected depending on the solubility of the oil-soluble dye and the oil-soluble polymer. Examples thereof include ketone-based solvents such as acetone, methyl ethyl ketone and diethyl ketone, alcohol-based solvents such as methanol, ethanol, 2-propanol, 1-propanol, 1-butanol and tert-butanol, chlorine-based solvents such as chloroform and methylene chloride, aromatic solvents such as benzene and toluene, ester-based solvents such as ethyl acetate, butyl acetate and isopropyl acetate, ether-based solvents such as diethyl ether, tetrahydrofuran and dioxane, glycol ether-based solvents such as ethylene glycol monomethyl ether and ethylene glycol dimethyl ether.

The organic solvents may be used singly, or in combination of two or more thereof. Depending on the solubility of the oil-soluble dye or polymer, the solvent may be a mixture with water.

The amount of the organic solvent used is not particularly limited insofar as the effects of the invention are not adversely affected. Usually, the amount of the organic solvent is preferably 10 to 2,000 parts by mass, and more preferably 100 to 1,000 parts by mass, relative to 100 parts by mass of the oil-soluble polymer.

If the amount of the organic solvent used is smaller than 10 parts by mass, a fine and stable dispersion of colored particles may become hardly obtained. If the amount is larger than 2,000 parts by mass, a step of removing the solvent and a step of concentrating operation are inevitable to thereby become a complicated process, and an ink formulation may become impossible.

When the vapor pressure of the organic solvent is higher than that of water, it is preferable to remove the organic solvent from the standpoints of stability of the colored fine particle dispersion, safety and health. The method of removing the organic solvent may be conducted by any known methods depending on the types of solvents, that is, by evaporation, vacuum evaporation, ultrafiltration, etc. The step of removing the organic solvent is preferably carried out as soon as possible after emulsifying operation.

<Hydrophilic Organic Solvent>

The hydrophilic organic solvent is used for the purpose of preventing drying or of accelerating penetration. The hydrophilic organic solvent is preferably a hydrophilic organic solvent having a lower vapor pressure than that of water. Specific examples thereof include polyvalent alcohols such as ethylene glycol, propylene glycol, diethylene glycol, polyethylene glycol, thiodiglycol, dithiodiglycol, 2-methyl-1,3-propane diol, 1,2,6-hexane triol, glycerin, trimethylol propane and diethanol amine, substituted or unsubstituted aliphatic monovalent alcohols such as amyl alcohol, furfuryl alcohol, diacetone alcohol, ethylene glycol monoethyl ether, diethylene glycol monomethyl ether and triethylene glycol monoethyl ether, heterocyclic compounds such as 2-pyrrolidone, N-methyl-2-pyrrolidone, 1,3-dimethyl-2-imidazolidinone and N-ethyl morpholine, and sulfur-containing compounds such as sulfolane, dimethyl sulfoxide and 3-sulfolene.

Among these solvents, polyvalent alcohols and substituted or unsubstituted aliphatic monovalent alcohols are preferable, with polyvalent alcohols such as glycerin and diethylene glycol being more preferable. The hydrophilic organic solvents may be used singly, or in combination of two or more kinds thereof.

The hydrophilic organic solvent is contained in an amount of preferably 5 to 60% by mass, more preferably 7 to 50% by mass, and still more preferably 10 to 40% by mass, relative to the ink.

<Surfactant>

The surfactant is added to the ink composition for the purpose of mainly adjusting the dynamic surface tension thereof. The surfactants include a nonionic, cationic or anionic surfactant. Examples of the anionic surfactant include fatty acid salts, alkyl sulfuric acid ester, alkyl aryl sulfonic acid salts (e.g., alkyl benzene sulfonic acid salt, petroleum sulfonic acid salt, etc.), dialkyl sulfosuccinic acid salt, alkyl phosphoric acid ester salt, naphthalene sulfonate-formalin condensates and polyoxyethylene alkyl sulfuric acid ester salt. Examples of the nonionic surfactant includes acetylene-based diols (e.g., 2,4,7,9-tetramethyl-5-decyne-4,7-diol, etc.), polyoxyethylene alkyl ethers (e.g., polyoxyethylene decyl ether, acetylene diol/ethylene oxide adduct, etc.), polyoxyethylene fatty acid esters, sorbitan fatty acid esters, polyoxyethylene sorbitan fatty acid esters, polyoxyethylene alkyl amines, glycerin fatty acid esters, oxyethylene/oxypropylene block copolymers, etc.

Besides, amine oxide-based amphoteric surfactants such as N,N-dimethyl-N-alkyl amine oxide are also preferable. Further, surfactants described on pages 37 to 38 in JP-A No. 59-157,636 and in Research Disclosure No. 308119 (1989) may also be used.

Because of unlikeliness of precipitation and separation from ink and low foamability, it is preferable to use an anionic surfactant having a hydrophobic 2 chains or a branched hydrophobic moiety, an anionic surfactant having a hydrophilic group around at the center of a hydrophobic moiety, a nonionic surfactant having a hydrophobic 2 chains or a branched hydrophobic moiety (e.g., one terminal ester of polyethylene oxide of 2-butylocatanoate, an undecane-6-ol/polyethylene oxide adduct, etc.), and a nonionic surfactant having a hydrophilic group around at the center of a hydrophobic moiety (e.g., acetylene-based diol/ethylene oxide adduct (SURFYNOL Series (Air Products & Chemicals Inc.)). It is preferable that these surfactants have a molecular weight of 200 to 1,000, more preferably 300 to 900, and particularly preferably 400 to 900.

The amount of the surfactant to be added is preferably 0.5 to 5.0% by mass, particularly preferably 1.0 to 3.0% by mass, relative to the ink composition.

The dynamic surface tension of the ink of the present invention is adjusted to be 25 to 35 mN/m using the surfactant or the hydrophilic organic solvent. The dynamic surface tension is more preferably 27 to 33 mN/m. Incidentally, the dynamic surface tension is a value determined by a measuring device through a maximum foaming pressure method, and the foaming generation period is specified to be 100 ms or more.

In order to adjust the dynamic surface tension within such a range, the addition amount of the surfactant is controlled to at least 1% of the total solids.

<Additives>

The ink composition of the invention may also contain additives suitably selected depending on the purposes such that the effect of the invention is not adversely affected.

Examples of the additive include a neutralizing agent, a hydrophobic high-boiling point organic solvent, a dispersant and a dispersion stabilizer.

If the oil-soluble polymer has a non-neutralized dissociable group, the neutralizing agent may preferably be used for adjusting the pH of the colored fine particle dispersion, for regulating self-emulsifiability and for conferring dispersion stability.

Examples of the neutralizing agent include an organic base, an inorganic alkali, and the like.

Representative examples of the organic base include triethanolamine, diethanolamine, N-methyldiethanolamine and dimethylethanolamine.

Specific examles of the inorganic alkali include alkali metal hydroxides (e.g., sodium hydroxide, lithium hydroxide, potassium hydroxide), carbonates (e.g., sodium carbonate, sodium bicarbonate) and ammonia.

From the standpoint of improving the stability of the colored fine particle dispersion, the neutralizing agent is added preferably for adjusting the pH value to 4.5 to 10.0, and more preferably 6.0 to 10.0

The hydrophobic high-boiling point organic solvent is used for controlling the viscosity, specific gravity and printing performance of the colored fine particle dispersion. The hydrophobic high-boiling point organic solvent is a hydrophobic solvent having a boiling point of preferably 150° C. or more, and more preferably 170° C. or more. The term “hydrophobic” as used herein means that solubility in distilled water at 25° C. is 3% or less. The dielectric constant of the hydrophobic high-boiling point organic solvent preferably ranges from 3 to 12, and more preferably from 4 to 10. The dielectric constant means a relative dielectric constant measured at 25° C. relative to vacuum. The hydrophobic high-boiling point organic solvent may be the compounds described in U.S. Pat. No. 2,322,027 and Japanese Patent Application No. 2000-78531. Specifical examples thereof include phosphoric acid triesters, phthalic acid diesters, alkyl naphthalenes and aromatic acid esters. The hydrophobic high-boiling point organic solvent for use in the invention may have any form of a liquid and solids at ordinary temperatures, depending on the purposes.

The amount of the high-boiling solvent used is not particularly limited insofar as the effect of the invention is not adversely affected. Usually, the amount thereof is preferably 0 to 1,000 parts by mass, and more preferably 0 to 300 parts by mass, relative to 100 parts by mass of the oil-soluble polymer.

The dispersant and/or the dispersion stabilizer may be added to the polymer latex, the oil-soluble dye-containing solution, the polymer/oil-soluble dye mixture, the fine dye particle dispersion, the polymer solution or the liquid containing at least water, but is preferably added to the oil-soluble dye-containing solution or the liquid containing at least water prior to the step of preparing the polymer latex and/or the fine dye particle dispersion.

Examples of the dispersant and the dispersion stabilizer include a wide variety of cationic, anionic or nonionic surfactants, water-soluble or water-dispersible low-molecular compounds, oligomers, etc. The amount of the dispersant and dispersion stabilizer to be added is 0 to 100% by mass, and more preferably 0 to 20% by mass, relative to the total amount of the oil-soluble dye and the oil-soluble polymer.

(Ink Composition, Ink for Ink-Jet, and Ink-Jet Recording Method)

The ink composition and the ink for ink-jet recording according to the invention comprise the colored fine particle dispersion and, as necessary, other additives suitably selected depending on the purposes. The oil-soluble dye contained in the ink composition acts as a dye or a colorant on a material to undergo recording. The ink composition is preferably used for ink-jet recording.

The ink for ink-jet recording according to the invention may be applied to any ink-jet recording systems. Preferably, the ink is employed in, for example, a charge regulating system in which an ink is discharged utilizing a static attraction force, a drop-on-demand system (pressure pulse system) in which an oscillating pressure of a piezo element is utilized, an acoustic ink-jet system in which electric signals are converted into acoustic beams with which an ink is to be irradiated to cause an ejection of the ink by radiation pressure, and a thermal ink-jet (bubble jet (R)) system in which an ink is heated to form bubbles and the generated pressure is utilized.

The ink-jet recording system includes a system in which a large number of ink droplets having a low concentration and called a photo-ink is ejected in a, a system in which image qualities is improved using a plurality of inks substantially identical in hues but different in concentrations, and a system in which a colorless transparent ink is used.

-Other Additives-

As the additives, a hydrophilic organic solvent, a viscosity modifier, a dispersant, a dispersion stabilizer, an antioxidant, a mildew-proofing agent, a rust preventive, a pH regulator, a defoaming agent, a chelating agent, a UV absorbent, etc. may suitably be selected and used in appropriate amounts. As these additives, known compounds described in, for example, JP-A No. 2001-181549 may also be used.

In the invention, the viscosity of the ink is preferably 30 mPa·s or less. The viscosity is more preferably 20 mPa·s or less, and for the purpose of regulating the viscosity, a viscosity regulator may be used. The viscosity regulator includes, for example, water-soluble polymers such as cellulose and polyvinyl alcohol.

Known compounds described in JP-A No. 2001-181549 etc. may be used as additives such as a dispersant, a dispersion stabilizer, an antioxidant, a mildew-proofing agent, a rust preventive, a pH regulator, a defoaming agent, a chelating agent and a UV absorbent.

-Material to Undergo Recording-

The materials to undergo recording through an ink-jet recording method according to the invention using the ink include a plain paper, a coated paper, a plastic film, etc. Use of a coated paper as the material to undergo recording provides improvement in image qualities and hence is preferable. The materials to undergo recording are described in JP-A No. 2001-181549, etc.

### EXAMPLES

The present invention will now be described in more detail by reference to the Examples, but the invention is not limited to the Examples. In the following Examples, “part(s)” and “%” are all by mass, unless otherwise specified.

### PRODUCTION EXAMPLES

### Production Example 1

### Preparation of Colored Fine Particle Dispersion (B-1)

Sodium hydroxide (2 mol/L) was gradually added to a mixed solution of 4 parts of tetrahydrofuran, 6 parts of tert-butanol, 1.5 parts of an oil-soluble polymer (PA-6) and 0.5 part of an oil-soluble dye (a-17), shown later, in an amount to neutralize the acid of the oil-soluble polymer, and the resultant mixture was heated to 70° C. Thereafter, the mixture was emulsified with stirring by gradually adding 30 parts of water. The obtained solution was concentrated at 30° C. under reduced pressure, to prepare a colored fine particle dispersion having a solids content of 16%. The particle diameter of the colored fine particles in the colored fine particle dispersion was 22 nm in terms of volume average diameter (determined by Microtruck UPA150 manufactured by Nikkiso Co., Ltd.). Hereinafter, this dispersion is referred to as a colored fine particle dispersion (B-1).

### Production Example 2

### Preparation of Colored Fine Particle Dispersion (B-2)

A mixed solution containing 3 parts of ethyl acetate, 0.5 part of cyclohexanone, 1.4 parts of an oil-soluble polymer (PA-1) and 0.6 part of an oil-soluble dye (a-17) was prepared. Separately, another mixed solution containing a 2 mol/L sodium hydroxide in an amount to neutralize the acid of the oil-soluble polymer, 15 parts of water and 0.3 part of sodium di(2-ethylhexyl)sulfosuccinate was prepared. The above two mixed solutions were combined, mixed and emulsified using a homogenizer, and concentrated at 30° C. under reduced pressure, to prepare a colored fine particle dispersion having a solids content of 13.3%. The particle diameter of the colored fine particles in the colored fine particle dispersion was 82 nm in terms of volume average diameter. Hereinafter, this product is referred to as a colored fine particle dispersion (B-2).

### Production Example 3

### Preparation of Colored Fine Particle Dispersion (B-3)

A mixed solution containing 3 parts of ethyl acetate, 0.5 part of cyclohexanone, 0.8 part of an oil-soluble polymer (PA-9), 0.6 part of an oil-soluble dye (a-17), and 0.4 part of a hydrophobic high-boiling point organic solvent (S-1), shown later, was prepared. Separately, another mixed solution containing a 2 mol/L sodium hydroxide in an amount to neutralize the acid of the oil-soluble polymer, 15 parts of water and 0.3 part of sodium di(2-ethylhexyl)sulfosuccinate was prepared. The above two mixed solutions were combined, mixed and emulsified using a homogenizer, and concentrated at 30° C. under reduced pressure, to prepare a colored fine particle dispersion having a nonvolatile ingredient content of 14.0%. The particle diameter of the colored fine particles in the colored fine particle dispersion was 77 nm in terms of volume average diameter. Hereinafter, this product is referred to as a colored fine particle dispersion (B-3).

### Production Example 4

### Preparation of Colored Fine Particle Dispersion (B-4)

6.4 parts of an oil-soluble dye (a-7) shown below, 7.0 parts of sodium dioctylsulfosuccinate and 7.8 parts of an oil-soluble polymer (PA-10) were dissolved at 70° C. in 5.0 parts of the hydrophobic high-boiling point organic solvent (S-1) and 50 parts of ethyl acetate. To the resultant mixture was added 400 parts of deionized water with stirring using a magnetic stirrer, to prepare a coarse particle dispersion of oil-in-water type. Then, this coarse particle dispersion was pulverized finely by passing 5 times through a microfluidizer (Microfluidex Inc.) at a pressure of 600 bar. The resulting emulsion was concentrated to 160 parts using a rotary evaporator. The particle diameter of the colored fine particles in the colored fine particle dispersion was 48 nm in terms of volume-average diameter. Hereinafter, this dispersion is referred to as a colored fine particle dispersion (B-4).

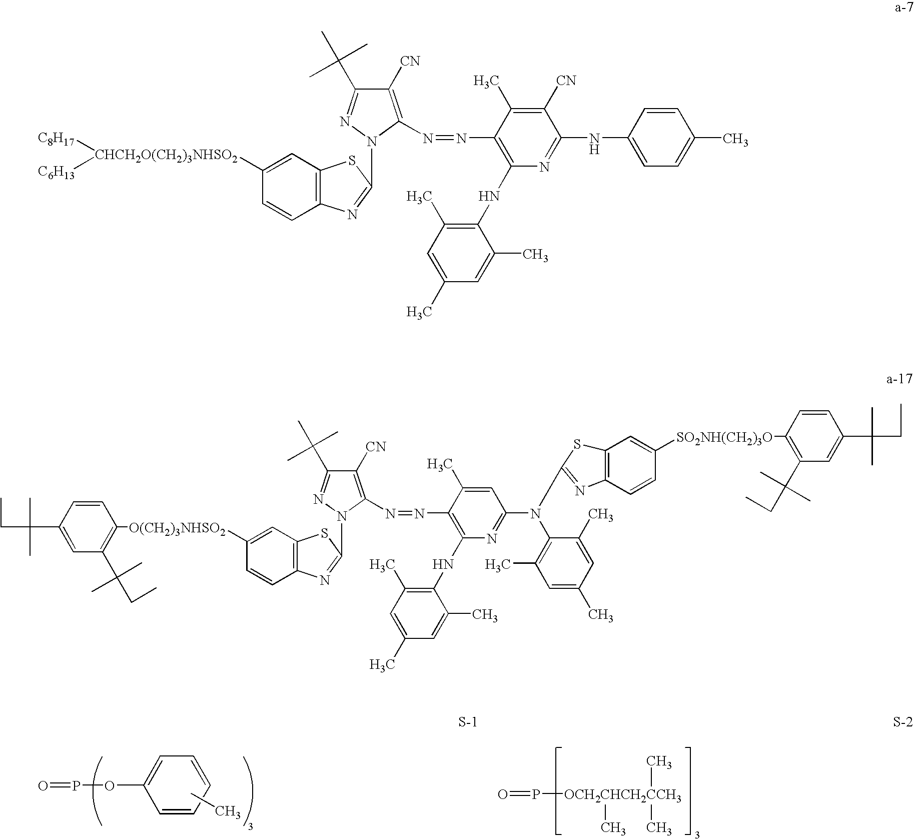

### Production Examples 5 to 10

A colored fine particle dispersion of Production Example 5 was produced in the same manner as in Production Example 1, another colored fine particle dispersion of Production Example 6 was produced in the same manner as in Production Example 2, and colored fine particle dispersions of Production Examples 7 to 10, respectively, were produced in the same manner as in Production Example 3. The oil-soluble polymers and oil-soluble dyes used for production are shown in Table 1 below.

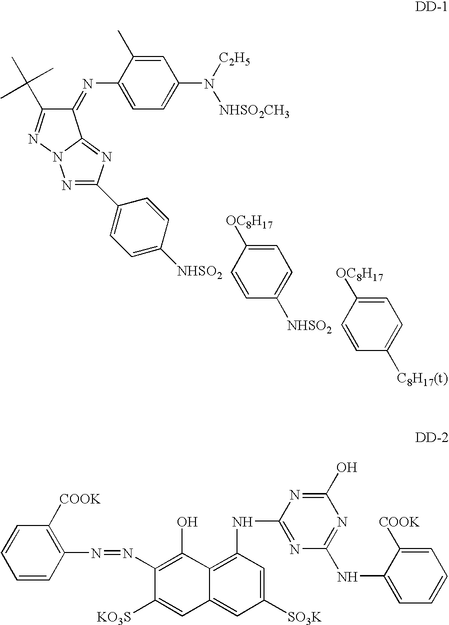

TABLE 1

| | | | Hydrophobic | | Particle |
|---|---|---|---|---|---|
| | Oil- | | High-Boiling | | Di- |
| Production | Soluble | | Point Organic | | ameter |
| Example | Polymer | Dye | Solvent | Dispersibility | (nm) |
| 1 | PA-6 | a-21 | — | Good | 22 |
| 2 | PA-1 | a-21 | — | Good | 82 |
| 3 | PA-9 | a-21 | S-1 | Good | 77 |
| 4 | PA-10 | a-7 | S-1 | Good | 35 |
| 5 | P-7^{Note 1)} | a-21 | — | Good | 48 |
| 6 | P-15 | a-21 | — | Good | 78 |
| 7 | PA-3 | a-21 | S-1, S-2^{Note 2)} | Good | 74 |
| 8 | PA-5 | a-21 | S-1, S-2^{Note 2)} | Good | 70 |
| 9 | PA-7 | a-21 | S-1, S-2^{Note 2)} | Good | 65 |
| 10 | PA-9 | DD-1 | S-1, S-2^{Note 2)} | Good | 71 |

^{Note 1)}Compound P-7) described in JP-A No. 2001-226613
^{Note 2)}S-1 and S-2 were used in the following weight ratio: S-1/S-2 = 36/64.

As is evident from the results shown in the above table, colored fine particle dispersions having a smaller particle diameter can be produced which are excellent in dispersibility without causing aggregation.

### Example 1

<Preparation of Ink 01>

The following ingredients were mixed and filtered through a 0.45 μm filter, to prepare an aqueous ink-jet recording ink 01.

| | |
|---|---|
| Colored fine particle dispersion (B-1) | 50 parts |
| Diethylene glycol | 8 parts |
| Tetraethylene glycol monobutyl ether | 2 parts |
| Glycerin | 5 parts |
| Diethanolamine | 1 part |
| Polyethylene glycol (average number | 2 grams |
| of ethylene oxide repeating units: | |
| 10)-terminated 2-butyl octanoic acid ester | |
| Water | to make a total |
| | amount of |
| | 100 parts |

### Example 2

<Preparation of Ink 02>

An aqueous ink-jet recording ink 02 was prepared in the same manner as in preparation of the ink 01, except that the colored fine particle dispersion (B-2) obtained in Production Example 2 was used in place of the colored fine particle dispersion (B-1).

### Example 3

<Preparation of Ink 03>

The following ingredients were mixed and filtered through a 0.45 μm filter, to prepare an aqueous ink-jet recording ink 03.

| | |
|---|---|
| Colored fine particle dispersion (B-3) | 50 parts |
| Diethylene glycol | 8 parts |
| Tetraethylene glycol monobutyl ether | 2 parts |
| Glycerin | 5 parts |
| Diethanolamine | 1 part |
| Olefin E1010 | 1.5 parts |
| Water | to make a total |
| | amount of |
| | 100 parts |

### Examples 4 to 7

<Preparation of Inks 04 to 07>

Aqueous ink-jet recording inks 04 to 07 were prepared in the same manner as in preparation of the ink 03, except that the colored fine particle dispersions (B-4) to (B-7) obtained in Production Examples 4 to 7, respectively, were used in place of the colored fine particle dispersion (B-3).

### Examples 8 to 10

<Preparation of Inks 08 to 10>

Aqueous ink-jet recording inks 08 to 10 were prepared in the same manner as in preparation of the ink 03, except that the amount of Olefin E1010 was changed to the amounts as shown in Table 2.

### Example 11

<Preparation of Ink 11>

An aqueous ink-jet recording ink 11 was prepared in the same manner as in preparation of the ink 03, except that 1.7 parts of the following surfactant was further added.

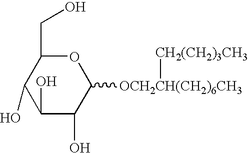

### Example 12

<Preparation of Ink 12>

The following ingredients were mixed and filtered through a 0.45 μm filter, to prepare an aqueous ink-jet recording ink 12.

| | |
|---|---|
| Water-and oil-soluble dye DD-2 | 25 parts |
| Diethylene glycol | 8 parts |
| Tetraethylene glycol monobutyl ether | 5 parts |
| Glycerin | 5 parts |
| Diethanolamine | 1 part |
| Polyethylene glycol (average number | 1 gram |
| of ethylene oxide repeating units: | |
| 10)-terminated 2-butyl octanoic acid | |
| ester | |
| Water | to make a total |
| | amount of |
| | 100 parts |

-Image Recording and Evaluation-

Each of the prepared inks 01 to 12 was charged in a cartridge of an ink-jet printer MC-2000 (manufactured by Seiko Epson Corporation), and an image was recorded using this printer on a paper for PPC and on an ink-jet paper (photo glossy paper, manufactured by Fuji Photo Film Co., Ltd.) and evaluated in the following manner. The evaluation results are shown in Table 2.

<Dynamic Surface Tension>

Measurement was conducted under the condition of a foaming period of 100 ms or more using a BP-D3 machine manufactured by Kyowa Interface Science Co., Ltd. (maximum foaming pressure method)

<Evaluation of Printing Performance>

The cartridge was set in the printer, and after ejection of ink droplets from all nozzles was confirmed, images were recorded on ten A4 paper sheets, and disturbance of printing was evaluated according to the following criteria.

A: There was no disturbance throughout printing.

B: There was disturbance occasionally throughout printing.

C: There was disturbance throughout printing.

<Evaluation of Paper Dependency>

The tone of color of the images formed on the photo glossy paper was compared with the tone of color of the images formed on the paper for PPC, and evaluation was conducted in 3 ranks, that is, when there was less difference between the images, score A was given, when there was a slight difference therebetween, score B was given, and when there was a significant difference therebetween, score C was given.

<Evaluation of Water Resistance>

The photo glossy paper on which an image had been formed was dried for 1 hour at room temperature, then dipped in water for 30 seconds, and air-dried at room temperature, and bleeding occurence was observed. Evaluation was conducted in 3 ranks, that is, when there was no bleeding, score A was given, when there was slight bleeding, score B was given, and when there was significant bleeding, score C was given.

<Evaluation of Light Resistance>

The photo glossy paper on which images had been formed was irradiated with xenon rays (85,000 lx) using a weather meter (Atlas C.I65) for 10 days, and density of the images formed before and after the irradiation with xenon rays was measured using a reflective densitometer (X-Rite 310TR), to determine the remaining dye ratio. The reflective density was measured at 3 points of 1, 1.5 and 2.0.

Evaluation was conducted in 3 ranks, that is, when the remaining dye ratio was 80% or more at any density, score A was given, when the remaining dye ratio was less than 80%, score B was given, and when the remaining dye ratio was less than 70%, score C was given.

<Ozone Resistance>

Ozone resistance was evaluated by measuring the density of the samples using X-rite 310, before and after storage for 3 days under the conditions of 1.0 ppm ozone concentration to thereby determine the remaining oil-soluble dye ratio. Evaluation was conducted in 5 ranks, in which score A was given when the remaining dye ratio was 90% or more, score B was given in the case of 80 to 89%, score C was given in the case of 70 to 79%, score D was given in the case of 50 to 69%, and score E was given in the case of less than 49%.

TABLE 2

| | Colored Fine | | Dynamic | | | | | | |
|---|---|---|---|---|---|---|---|---|---|
| | Particle | | Surface | Printing | Paper | Water | Light | Ozone | |
| Ink No. | Dispersion | Surfactant | Tension | Performance | Dependency | Resistance | Resistance | Resistance | Remarks |
| 01 | B-1 | 2.0 | 31.2 | A | A | A | A | A | Present Invention |
| 02 | B-2 | 2.0 | 31.1 | A | A | A | A | A | Present Invention |
| 03 | B-3 | 1.5 | 32.0 | A | A | A | A | A | Present Invention |
| 04 | B-4 | 1.5 | 32.3 | A | A | A | A | A | Present Invention |
| 05 | B-6 | 1.5 | 33.8 | A | A | A | A | A | Present Invention |
| 06 | B-8 | 1.5 | 32.7 | A | A | A | A | A | Present Invention |
| 07 | B-10 | 1.5 | 31.9 | A | A | A | A | D | Present Invention |
| 08 | B-3 | 0.2 | 39.0 | C | A | A | A | A | Comparative Example |
| 09 | B-3 | 0.5 | 35.2 | B | A | A | A | A | Present Invention |
| 10 | B-3 | 3.0 | 28.5 | A | A | A | A | A | Present Invention |
| 11 | B-3 | 3.2 | 27.9 | B | A | A | A | A | Present Invention |
| 12 | None | 1.0 | 30.0 | A | B | C | C | E | Comparative Example |

As clear from the above table, the ink compositions according to the present invention were superior to a comparative water-soluble dye ink 12 in paper dependency, water resistance, light resistance and ozone resistance. Another comparative ink 08 which had a high dynamic surface tension was poor in printing performance, whereas the ink compositions according to the invention were excellent in printing performance.

As detailed above, the present invention can provide an ink-jet recording ink which is excellent in ejectibility through nozzles when printing is performed, free of water dependency and good in water resistance, light resistance and ozone resistance, as well as an ink-jet recording method suitable for use with the ink.

What is claimed is:

1. An aqueous ink composition comprising a hydrophilic organic solvent, a surfactant, and a colored fine particle dispersion which contains an oil-soluble dye, and exhibiting a dynamic surface tension of 25 to 35 mN/m.

2. The aqueous ink composition according to claim 1, wherein the colored fine particles contain the oil-soluble dye and an oil-soluble polymer.

3. The aqueous ink composition according to claim 1, wherein the oil-soluble dye has a melting point of 200° C. or less.

4. The aqueous ink composition according to claim 1, wherein the oil-soluble dye is selected from the group consisting of an anthraquinone-type dye, a naphthoquinone-type dye, a styryl-type dye, an indoaniline-type dye, an azo-type dye, a nitro-type dye, a coumarin-type dye, a methine-type dye, a porphyrin-type dye, an azaporphyrin-type dye and a phthalocyanine-type dye.

5. The aqueous ink composition according to claim 4, wherein the dye is contained in an amount of 0.05 to 50% by mass relative to the ink composition.

6. The aqueous ink composition according to claim 2, wherein the oil-soluble polymer has a carboxyl group as a dissociative group.

7. The aqueous ink composition according to claim 2, wherein the oil-soluble polymer has a molecular weight (Mw) of 1,000 to 200,000.

8. The aqueous ink composition according to claim 2, wherein the oil-soluble polymer is selected from the group consisting of a vinyl polymer, polyurethane and polyester.

9. The aqueous ink composition according to claim 2, wherein the oil-soluble polymer is used in an amount of 10 to 1,000 parts by mass relative to 100 parts by mass of the oil-soluble dye.

10. The aqueous ink composition according to claim 1, wherein the colored fine particles are contained in an amount of 1 to 45% by mass relative to the colored fine particle dispersion.

11. The aqueous ink composition according to claim 1, wherein an average particle diameter of the colored fine particles is 1 to 500 nm.

12. The aqueous ink composition according to claim 1, wherein the hydrophilic organic solvent is selected from the group consisting of a polyvalent alcohol, an aliphatic monovalent alcohol, a heterocyclic compound and a sulfur-containing compound.

13. The aqueous ink composition according to claim 1, wherein the hydrophilic organic solvent is contained in an amount of 5 to 60% by mass relative to the ink composition.

14. The aqueous ink composition according to claim 1, wherein a molecular weight of the surfactant is 200 to 1,000.

15. The aqueous ink composition according to claim 1, wherein the surfactant is contained in an amount of 0.5 to 5.0% by mass relative to the ink composition.

16. The aqueous ink composition according to claim 1, further comprising an additive selected from the group consisting of a neutralizing agent, a hydrophobic high-boiling point organic solvent, a dispersant and a dispersion stabilizer.

17. The aqueous ink composition according to claim 1, wherein a viscosity of the ink is 30 mPa·s or less.

18. An ink-jet recording method comprising a step of carrying out recording using an aqueous ink composition which comprises a hydrophilic organic solvent, a surfactant, and a colored fine particle dispersion containing an oil-soluble dye, and exhibits a dynamic surface tension of 25 to 35 mN/m.

19. The ink-jet recording method according to claim 18, using a system selected from the group consisting of a charge regulating system, a drop-on-demand system, an acoustic inkjet system and a thermal ink-jet system.

20. The ink-jet recording method according to claim 18, wherein a material to undergo recording is selected from the group consisting of a plain paper, a coated paper and a plastic film.
